(19) United States
(12) Patent Application Publication
(10) Pub. No.: US 2006/0040193 A1
(43) Pub. Date: Feb. 23, 2006

(54) Organic photoreceptor, image forming apparatus, image forming method and image forming unit

(76) Inventor: Akihiko Itami, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 10/924,596

(22) Filed: Aug. 23, 2004

(51) Int. Cl. G03G 5/047

(52) U.S. Cl. 430/58.05; 399/159

(57) ABSTRACT

An organic photoreceptor comprising a conductive support on which a charge generating layer and a charge transporting layer are stacked in that order, wherein a changing rate of an exposure energy change (E_{600/100})ₙ is not larger than 0.01 (μJ/(cm²·μm)) when a thickness of the charge transporting layer n decreases from 20 μm to 15 μm and when a surface potential of the organic photoreceptor varies from −600 V to −100 V, the changing rate of the exposure energy change (E_{600/100})ₙ being defined by the following formula:
((E_{600/100})₂₀−(E_{600/100})₁₅)/(20−15)

### TECHNICAL FIELD

The present invention related to an organic photoreceptor, and image forming apparatus, an image formation method and an image formation unit used for copying machines, printers and facesimile apparatuses.

### BACKGROUND

As one of color image formation methods, an image formation method so-called a tandem method has been known, in which color toner image are formed on separate photoreceptors, each of which has a different single color, and the images are superimposed on an intermediate transfer member or on a recording member. (Patent Document 1).

However, since the tandem method utilizes a separate photoreceptor for each color, it easily results in color shading or color misalignment unless the ability of each photoreceptor is stable.

Alternatively, in order to increase quality of color images, a technology to form minute dot images has been developed, in which a minute latent image is formed on an organic photoreceptor using an exposure light focused to a minute spot size. For example, a method to form a high resolution latent image using a light source having a spot size of not more than 4000 μm² has been reported.(Patent Document 2). In a minute spot exposure system, it is important to suppress diffusion of charge carriers generated by exposure of light in an image-wise exposure step on a photoreceptor to form an accurate latent image. Namely, it is important to maintain a sufficient contrast in electric potential between exposed and unexposed parts and this is achieved by suppressing diffusion of the generated carriers before the carries reach the surface of the photoreceptor.

It has been reported (in Non-patent Document 1 described later) that when the ratio D/μ of a diffusion constant (D) to drift mobility (μ) is great, influence of diffusion during electrostatic latent image formation is not negligible and that when the layer thickness of the charge transporting layer is larger, degradation of latent image increases.

An organic photoreceptor in which the diffusion of a electrostatic latent image is suppressed by using a thinner charge transporting layer has already been reported (Patent Document 3).

However, these cited organic photoreceptors are not fully sufficient solutions with respect to durability of the photoreceptor. Specifically, charging performance and sensitivity of an organic photoreceptor are in general greatly dependent on the layer thickness, and a decrease in the layer thickness due to repeated use tends to cause an increase in image defects such as fogging and black spots. Specifically, in an organic photoreceptor with a thin photoreceptive layer, loading conditions of charging potential in the electrostatic latent image forming step tend to increase the electric field intensity per unit layer thickness, which easily causes the problems mentioned above.

When a thin layer organic photoreceptor is used in a tandem type image forming apparatus, abrasion of a photoreceptor for black color proceeds faster than that for other colors Y(yellow), M(magenta) and C(cyan) due to the more frequent use of black color-compared to other colors. Accordingly, the following problem has been pointed out, in that, in an all-in-one type image forming unit containing photoreceptors for Y(yellow), M(magenta), C(cyan) and Bk(black), the life of the image forming unit is determined by the life of the photoreceptor for Bk, resulting the photoreceptors for other colors to be changed before reaching the end of their life time. In order to overcome this problem, several methods have been proposed, for example: (i) the thickness of the photoreceptor for black is increased, (ii) a lower abrasive cleaning system is provided in the photoreceptor for black. However, a thicker layer of the photoreceptor may result in a decrease in thin line reproducibility, and a lower abrasive cleaning system may cause toner filming on the photoreceptor surface due to a insufficient cleaning, and new image defects may occur. These problems tend to occur especially in a high resolution and high speed tandem type image forming system.

(Patent Document 1)

Japanese Patent Open to Public Inspection (hereinafter referred to as JP-A) 2001-222129

(Patent Document 2)

JP-A 8-272197

(Patent Document 3)

JP-A 5-119503

(Non-Patent Document 1)

Journal of the Imaging Society of Japan, 38(4), 296 (1999)

### SUMMARY OF THE INVENTION

An object of the present invention is to provide an organic photoreceptor having the following features. Firstly, the organic photoreceptor improves durability of thin layer type organic photoreceptors. Secondarily, the organic photoreceptor suppresses degradation of image density and occurrence of fogging and image defects of black spots and provides a sharper image, even after the layer thickness is decreased by abrasion over long-term use. Finally, when the organic photoreceptor is used in a tandem type image forming apparatus, the organic photoreceptor provides a durable image forming unit which gives high resolution dot images, as well as an image forming apparatus and image forming method which gives sharp images.

The present invention has been achieved by the finding that, by lowering the layer thickness dependence of sensitivity of an organic photoreceptor, only a small change in properties of an electrophotographic image forming system, for example, sensitivity and high resolution images, were obtained even after the layer thickness of the organic photoreceptor was decreased and, also, the above mentioned problem in tandem type image forming system was resolved.

### BRIEF DESCRIPTION OF DRAWINGS

FIG. 1 is a cross-sectional construction diagram showing an example of an image forming apparatus of a tandem intermediate transfer type;

FIG. 2 is a cross-sectional construction diagram of an image forming unit to be used in an image forming apparatus of the present invention;

FIG. 3 is a cross-sectional construction diagram showing another example of an image forming unit to be used in an image forming apparatus of the present invention;

FIG. 4 is a cross-sectional construction diagram of another image forming apparatus of the present invention;

FIG. 5(a) is an illustration showing a projected image of a toner particle having no corner, while FIG. 5(b) and FIG. 5(c) represent an illustration showing a projected image of toner particle having corners.

### DESCRIPTION OF THE PREFERRED EMBODIMENTS

The object of the present invention are achieved by the following structures:
1. An organic photoreceptor comprising a conductive support on which a charge generating layer and a charge transporting layer are stacked in that order, wherein a changing rate of an exposure energy change (E_{600/100})ₙ is not larger than 0.01 (μJ/(cm²·μm)) when a thickness of the charge transporting layer “n” decreases from 20 μm to 15 μm and when a surface potential of the organic photoreceptor varies from −600 V to −100 V, the changing rate of the exposure energy change (E_{600/100})ₙ being defined by the following formula:
   ((E_{600/100})₂₀−(E_{600/100})₁₅)/(20−15)
2. The organic photoreceptor of Item 1, wherein an initial thickness of the charge transporting layer is in a range of 10-20 μm.
3. An image forming apparatus comprising:
(a) a plurality of image forming units, each of which corresponds to a different color toner and each of the image forming units comprising:

(i) an organic photoreceptor,

(ii) a charging member which provides electric charge to the organic photoreceptor and a surface of the organic photoreceptor,

(iii) an image-wise exposure member which exposes light to a charged area of the organic photoreceptor so as to form an electrostatic latent image on the surface of the photoreceptor,

(iv) a developing member which forms a toner image corresponding to the electrostatic latent image using a color toner on the surface of the organic photoreceptor, and

(v) a cleaning member which removes the toner remaining on the surface of the organic photoreceptor; and
(b) a transferring member which receives the toner image formed on the organic photoreceptor and transfers the toner image onto a transferring object,

wherein, the organic photoreceptor comprises a conductive support on which a charge generating layer and a charge transporting layer are formed in that order and a changing rate of an exposure energy change (E_{600/100})ₙ is not larger than 0.01 (μJ/cm² μm) when a thickness of the charge transporting layer “n” decreases from 20 μm to 15 μm and when a surface potential of the organic photoreceptor varies from −600 V to −100 V, the changing rate of the exposure energy change (E_{600/100})ₙ being defined by the following formula:
((E_{600/100})₂₀−(E_{600/100})₁₅)/(20−15)
4. The image forming apparatus of Item 3, wherein a spot area of a spot image exposure light source used in the exposure member is not more than 2000 μm².
5. The image forming apparatus of Item 3 or Item 4, wherein an average particle diameter of toner particles in a developing powder used in the developing member is in a range of 2-8 μm.
6. An image forming method comprising a step of forming an electrophtographic image using the image forming apparatus of any one of Items 3-5.
7. An image forming unit for an image forming apparatus comprising:
(a) a plurality of image forming units, each of which corresponds to a different color toner and the each image forming unit comprising:

(i) an organic photoreceptor,

(ii) a charging member which provides electric charge to the organic photoreceptor and a surface of the organic photoreceptor,

(iii) an image-wise exposure member which exposes light to a charged area of the photoreceptor so as to form an electrostatic latent image on the surface of the photoreceptor,

(iv) a developing member which forms a toner image corresponding to the electrostatic latent image using a color toner on the surface of the organic photoreceptor, and

(v) a cleaning member which removes the toner remaining on the surface of the organic photoreceptor; and
(b) a transferring member which receives the toner image formed on the organic photoreceptor and transfers the toner image onto a transferring object,

wherein, the organic photoreceptor comprises a conductive support on which a charge generating layer and a charge transporting layer are formed in that order and a changing rate of an exposure energy change (E_{600/100})ₙ is not larger than 0.01 (μJ/(cm²·μm)) when a thickness of the charge transporting layer “n” decreases from 20 μm to 15 μm and when a surface potential of the organic photoreceptor varies from −600 V to −100 V, the changing rate of the exposure energy change (E_{600/100})ₙ being defined by the following formula:
(E_{600/100})₂₀−(E_{600/100})₁₅)/(20−15)

The present invention will be described in detail below.

The organic photoreceptor of the present invention is characterized by comprising a conductive support on which a charge generating layer and a charge transporting layer are stacked in that order, wherein the changing rate of the exposure energy change (E_{600/100})ₙ is not larger than 0.01 (μJ/(cm²·μm)) when thickness of the charge transporting layer “n” decreases from 20 μm to 15 μm, the changing rate of the exposure energy change (E_{600/100})ₙ being defined by the following formula when a surface potential of the organic photoreceptor varies from −600 V to −100 V
(E_{600/100})₂₀−(E_{600/100})₁₅)/(20−15).

An organic photoreceptor having the above mentioned structure enables: (i) to form a high resolution latent dot image; (ii) to provide superior thin line reproducibility; and (iii) to suppress occurrence of image defects and degradation of image quality, even after repeated formation of a considerable number of images.

The organic photoreceptor of the present invention has a structure which exhibits the following property, namely, the changing rate of an exposure energy change (E_{600/100})ₙ being not larger than 0.01 (μJ/(cm²·μm)) when a thickness of the charge transporting layer “n” decreases from 20 μm to 15 μm and when a surface potential of the organic photoreceptor varies from −600 V to −100 V. This structure is successfully constructed in combination of the following conditions (1)-(5):
(1) Lowering the dielectric constant of the binder in the charge transporting layer;
(2) Increasing the number of charge transporting groups per unit weight; A charge transporting material having a smaller molecular weight per one charge transporting group is preferably used to increase number of charge transporting groups per unit weight;
(3) Providing an under coat layer having a large electrical conductivity between the charge transporting layer and the conductive support;
(4) Providing a thicker under coat layer; and
(5) Decreasing the amount of residual solvents.

Examples of binder resins satisfying the above condition (1) include polystyrene and a styrene-butadiene copolymer.

A charge transporting material-satisfying the above condition (2) includes triaryl amine which has a small molecular weight per one charge transporting group. The molecular weight per one charge transporting group is preferably not more than 700, more preferably not more than 600 and most preferably not more than 400. Examples of these materials include the following compounds:

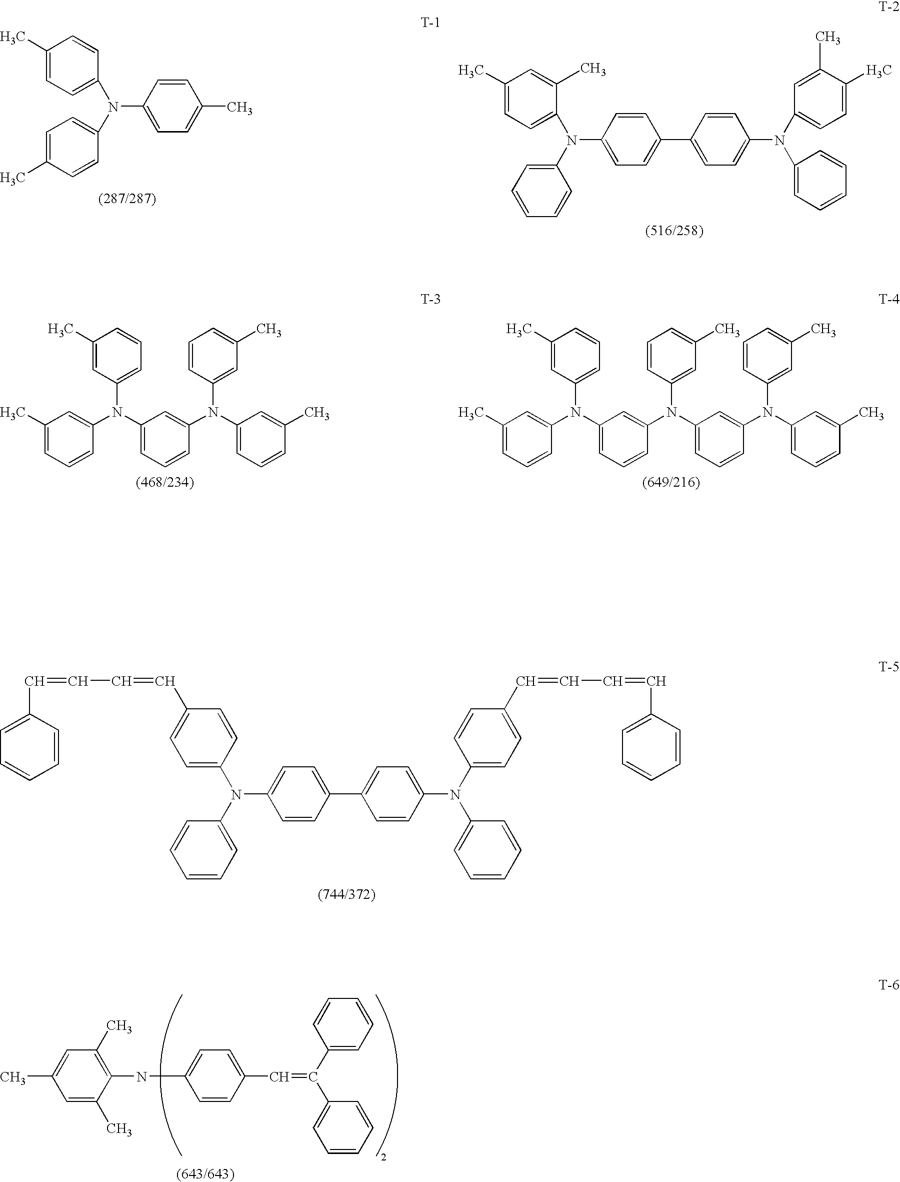

In the above compound, the figures in parenthesis represent a molecular weight and a molecular weight per one triaryl amine group in that order.

In order to increase the electrical conductivity of the under coat layer, anatase type titanium dioxide is dispersed in the binder of the under coat layer. Since anatase type titanium dioxide shows rather high electrical conductivity, increase in residual potential of the under coat layer remains small even when the thickness of the under coat layer is increased.

A binder resin containing an organic segment component and an inorganic segment component is used to disperse anatase type titanium dioxide in order to obtain a binder satisfying the above condition (4). This binder resin enhances the electrical conduction property of anatase type titanium dioxide and prevents an increase of residual potential when the thickness of the under coat layer is not less than 3.0 μm.

By using an organic photoreceptor satisfying the above conditions (1)-(5), the changing rate of an exposure energy change (E_{600/100})ₙ of not larger than 0.01 (μJ/(cm²·μm)) is attained.

The preferable changing rate of the exposure energy change (E_{600/100})ₙ is not larger than 0.01 (μJ/(cm²·μm)), however, more preferable changing rate of the exposure energy change (E_{600/100}), is not larger than 0.008 (μJ/(cm²·μm)). The lower the changing rate of an exposure energy change (E_{600/100})ₙ is, the longer superior dot reproducibility and sharp images can be maintained.

The photoreceptor of the present invention preferably has an initial charge transporting layer thickness of 10-20 μm. By setting the initial layer thickness of the charge transporting layer at 10-20 μm, an electrostatic latent image without fogging and an electrophotographic image exhibiting sufficient sharpness are obtained from the beginning.

In the following, details of the organic photoreceptor of the present invention will be described.

The organic photoreceptor of the present invention means an electrophotographic photoreceptor which comprises an organic compound having at least one of the indispensable functions for forming electrophotographic images, namely, a charge generating function or a charge transporting function. The organic photoreceptors of the present invention includes all types of organic photoreceptors well known in the art, for example, (i) an organic photoreceptor comprising a well known organic charge generating material or a well known organic charge transporting material and (ii) an organic photoreceptor comprising polymer complexes having a charge generating function and a charge transporting function.

A charge transporting layer of the present invention means a layer having a function to transport charge carriers which are generated in a charge generating layer by light exposure, to the surface of an organic photoreceptor, wherein this charge transporting function can be confirmed by laminating the charge generating layer and the charge transporting layer on a conductive support and detecting optical-conductivity.

The organic photoreceptor of the present invention has a basic structure of a photoreceptive layer comprised of a charge generating layer and a charge transporting layer on a conductive support.

The specific structure of a photoreceptor to be used in the present invention will be described below.

Conductive Support

A conductive support to be used in a photoreceptor of the present invention has a sheet shape or a cylindrical shape.

A conductive support in a cylindrical shape in the present invention means one that is necessary for endless forming of images by rotation, and it is preferably a conductive support having a straightness not greater than 0.1 mm and a fluctuation not greater than 0.1 mm. When the straightness and the fluctuation exceed these ranges, satisfactory image forming is difficult.

Examples of materials to be used for the conductive support include, for example, (i) metal drums of aluminum and nickel; (ii) plastic drums evaporated with aluminum, tin oxide, indium oxide and (iii) paper or plastic drums coated with a conductive material. A conductive support preferably has a specific resistance of 10³ Ω·cm or less at ambient temperature.

A conductive support to be used in the present invention may have a sealed alumite film formed on the surface thereof. Alumite processing is usually performed in an acid bath of, for example, chromic acid, sulfuric acid, oxalic acid, phosphoric acid, boric acid and sulfamic acid, wherein anodizing in sulfuric acid gives the most preferable result. In the case of anodizing in sulfuric acid, anodizing is preferably performed with a sulfuric acid concentration ranging from 100 to 200 g/l and aluminum ion concentration ranging from 1 to 10 g/l at a temperature of around 20° C., and with an applied voltage of about 20 V, however, not specifically limited. The average film thickness of the anodized layer is preferably 20 μm or less in usual cases, and it is specifically preferable to be 10 μm or less.

In the present invention, the above mentioned under coat layer in which anatase-type titanium oxide is dispersed is preferably provided between a conductive support and a photoreceptor layer. Herein, anatase-type titanium dioxide denotes a white titanium dioxide pigment exhibiting a refractive index of 2.55 and a tetragonal crystal structure having lattice constants: a=0.378 nm and c=0.947 nm.

The number average diameter of primary particles of the above mentioned anatase-type titanium dioxide is preferably 10-400 nm and more preferably 15-200 nm. Anatase-type titanium oxide having number average particle diameter of less than 10 nm may cause an insufficient moire suppressing effect by an under coat layer, while that of more than 400 nm tends to cause a settling of anatase-type titanium dioxide particles in a coating solution of an under coat layer resulting in less homogeneous dispersion of anatase-type titanium oxide in an under coat layer and an increasing number of appearance of black spots. An under coat layer coating solution using anatase-type titanium dioxide of which the number average particle diameter is in the above described preferable range shows stable dispersion of titanium oxide. An under coat layer prepared from the above described coating solution exhibits: (i) a preventing effect of appearance of black spots, (ii) a high durability for the environmental variation and (iii) an anti-cracking property.

Titanium oxide particles in the present invention are preferably subjected to surface treatment. One surface treatment includes divided surface treatments of a plurality of times, wherein the last surface treatment out of the surface treatments of the plurality of times is performed with a reactive organic silicon compound. Among the surface treatments of the plurality of times, a surface treatment of at least once is a surface treatment with at least one kind or more which are selected from alumina, silica, and zirconia, and, the last surface treatment is preferably performed with the reactive organic silicon compound.

Alumina treatment, silica treatment, or zirconia treatment deposits alumina, silica, or zirconia on the surfaces of titanium oxide particles, wherein alumina, silica, or zirconia deposited on the surfaces may be a hydrate thereof. Surface treatment with reactive organic silicon compound employs a reactive organic silicon compound as the treatment liquid.

As described above, twice or more of surface treatments of anatase-type titanium dioxide particles results in an uniformly surface treated titanium oxide particles and an under coat layer using thus surface treated titanium dioxide particles shows a homogeneous dispersion of titanium dioxide particles in a layer and enables to form a preferable photoreceptor without forming any image defects such as black spots.

Examples of the above mentioned reactive organic silicon compounds include compounds represented by Formula (2), however the compounds are not limited to those listed below when the compounds forms condensation compounds with hydroxyl groups existing on the surface of titanium dioxide. Formula (2)
(R)ₙ−Si−(X)₄₋ₙ

(In the formula, Si represents a silicon atom, R represents an organic group in which carbon is directly bonded with the silicon atom, X represents a hydrolysable group, and n represents integers from 0 to 3.

In the organic silicon compound represented by the general formula (1), the organic groups in the form where carbon is directly bound to the silicon atom include alkyl groups such as methyl, ethyl, propyl, butyl, pentyl, hexyl, octyl and dodecyl, aryl groups such as phenyl, tolyl, naphthyl and biphenyl, epoxy-containing groups such as γ-glycidoxypropyl and β-(3,4-epoxycyclohexyl)ethyl, (meth)acryloyl-containing groups such as γ-acryloxypropyl and γ-methacryloxypropyl, hydroxyl-containing groups such as γ-hydroxypropyl and 2,3-dihydroxypropyloxypropyl, vinyl-containing groups such as vinyl and propenyl, mercapto-containing groups such as γ-mercaptopropyl, amino-containing groups such as γ-aminopropyl and N-β(aminoethyl)-γ-aminopropyl, halogen-containing groups such as γ-chloropropyl, 1,1,1-trifluoropropyl, nonafluorohexyl and perfluorooctylethyl, and additionally, nitro-, cyano-substituted alkyl groups. The hydrolytic groups of X include alkoxy groups such as methoxy and ethoxy, halogen groups and acyloxy groups.

An organic silicon compound represented by Formula (2) may be used solely or in combination of two or more compounds.

In the case that n is 2 or more in a concrete compound that is an organic silicon compound expressed by Formula (2), each of a plurality of R may be the same or different from each other. Also, in the case that n is 2 or less, each of a plurality of X may be the same or different from each other. Further, in the case that two kinds or more of organic silicon compounds expressed by the Formula (2) are used, R and X may be the same or different from each other between the respective compounds.

A polysiloxane compound is a reactive organic silicon compound which is preferably used for surface treatment. Polysiloxane compounds of a molecular weight in the range of 1000-20000 are usually available and have a satisfactory function for preventing black spots.

Specifically, when methylhydrogen polysiloxane is used in the last surface treatment, an excellent effect is obtained.

A binder resin containing an organic or inorganic segment component is preferably used to form an under coat layer in which titanium dioxide particles are well dispersed and an increased electron transport property is provided.

Herein, an organic segment component denotes a component having a chain structure of a resin which contains a repeat unit of an organic compound (having carbon atoms in the chain structure).

Examples of the organic segment component include a chain structure component comprised in such as vinyl type resin, polyester type resin and polycarbonate type resin. A resin used for an under coat layer contains an organic segment component as a partial structure of a resin structure, together with an inorganic segment component.

An organic segment component is preferably prepared from a chain-polymerizable monomer. A vinyl type resin component prepared from a chain-polymerizable monomer of acrylic acid ester or methacrylic acid ester is specifically preferable to be used.

Alternatively, an inorganic segment component denotes a component having a chain structure of a resin which contains a repeat unit of an inorganic compound. As an example of a preferable inorganic segment component, a condensed siloxane component having chain structure of silicon and oxygen is listed.

A resin having condensed siloxane as an inorganic segment component in an organic segment component will be described in the following.

Conjugation of a condensed siloxsane with an organic segment component is carried out as follows: (i) a polymerizable silane compound of following Formula (1) having a polymerizable unsaturated group containing a unsaturated bond of carbon atoms is coexisted in materials to form an organic segment component; (ii) the polymerizable silane compound is co-reacted in a polymerizing reaction of a chain polymerizable monomer (a chain polymerizable monomers of an organic segment component)in a forming step of an organic segment component to form a silyl modified organic segment component in which a silyl group is introduced; and (iii) a condensed siloxane is formed at the silyl group or an already formed condensed siloxane is bonded.

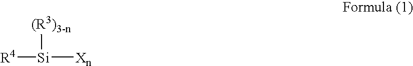

In Formula (1):
(i) R³ represents a hydrogen atom, an alkyl group having carbon number of 1 - 10 or an aralkyl group having carbon number of 1-10;
(ii) R⁴ represents an organic group having a polymerizable double bond;
(iii) X represents a halogen atom, an alkoxy group, an acyloxy group, an aminoxy group or a phenoxy group; and
(iv) n represents integer of 1-3.

The polymerizable silane compound of Formula (1) is not specifically limited when it has a silyl group, specifically, a hydrolysable silyl group and when it enables polymerization with chain polymerizable monomers listed below. Examples of the polymerizable silane compound include, for example: CH₂═CHSi(CH₃) (OCH₃)₂, CH₂═CHSi(OCH₃)₃, CH₂═CHSi(CH₃)Cl₂, CH₂═CHSiCl₃, CH₂═CHCOO(CH₂)₂Si(CH₃)(OCH₃)₂, CH₂═CHCOO(CH₂)₂Si(OCH₃)₃, CH₂═CHCOO(CH₂)₃Si(CH₃)(OCH₃)₂, CH₂═CHCOO(CH₂)₃Si(OCH₃)₃, CH₂═CHCOO(CH₂)₂Si(CH₃)Cl₂, CH₂═CHCOO(CH₂)₂SiCl₃, CH₂═CHCOO(CH₂)₃Si(CH₃)Cl₂, CH₂═CHCOO(CH₂)₃SiCl₃, CH₂═C(CH₃)COO(CH₂)₂Si(CH₃)(OCH₃)₂, CH₂═C(CH₃)COO(CH₂)₂Si(OCH₃)₃, CH₂═C(CH₃)COO(CH₂)₃Si(CH₃)(OCH₃)₂, CH₂═C(CH₃)COO(CH₂)₃Si(OCH₃)₃, CH₂═C(CH₃)COO(CH₂)₂Si(CH₃)Cl₂, CH₂═C(CH₃)COO(CH₂)₂SiCl₃, CH₂═C(CH₃)COO(CH₂)₃Si(CH₃)Cl₂, CH₂═C(CH₃)COO(CH₂)₃SiCl₃,

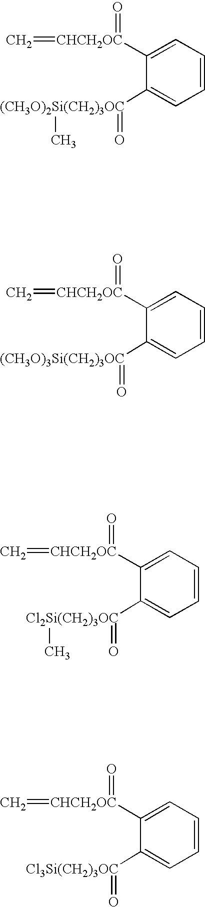

These polymerizable silane compounds may be used alone or in combinations.

Examples of a chain polymerizable monomer which form an organic segment compounds include, for example:
(i) (meth) acrylate esters, such as (meth) methyl acrylate, (meth) ethyl acrylate, (meth) butyl acrylate, (meth) 2-ethylhexyl acrylate, cyclohexyl (meth) acrylate;
(ii) carboxyl acids such as (meth) acrylic acid, itaconic acid and fumaric acid;
(iii) acid anhydrides such as maleic anhydride;
(iv) epoxy compounds such as glycidyl (meth) acrylate;
(v) amino compounds such as diethylaminoethyl (meth) acrylate and amino ethyl vinyl ether;
(vi) amides such as (meth) acrylamide, itaconic acid diamide, α-ethyl acrylamide, croton amide, fumaric acid diamide, maleic acid diamide and N-butoxymethyl (meth) acrylamide;
(vii) one or more vinyl type chain polymerizable monomers selected from a group of acrylonitrile, styrene, a-methylstyrene, chloroethylene, vinyl acetate and propionic acid vinyl; and
(viii) vinyl type chain polymerizable monomers containing a hydroxyl group such as 2-hydroxyethyl (meth) acrylate, 2-hydroxypropyl (meth) acrylate, 2-hydroxy vinyl ether and N-methylolacrylamide.

A photorecepter of the present invention is characterized by that an under coat layer contains resins having an organic segment component, an inorganic segment component and an antioxidation stractural component.

Herein, an antioxidation stractural component represents a group which is resistant for oxidation or for reduction caused by contacting with an active gases such as NOx or ozone and by being irradiated with an actinic ray such as UV ray.

A resin having an antioxidation stractural component denotes antioxidation stractural component such as hindered amine or hindered phenol is incorporated as a partial structure in a resin structure. An antioxidation stractural component is capable of introducing an antioxidation stractural component such as hindered amine or hindered phenol into an organic segment component.

Namely, a resin having an organic segment component, an inorganic segment component and an antioxidation stractural component is prepared by:

(i) forming an organic segment component having an antioxidation stractural component and a silyl group via polymerization reaction using (a) a chain polymerizable monomer to form an organic segment component, (b) a polymerizable monomer to form an antioxdation structural component, and (c) a polymerizable silane compound; followed by

(ii) forming a condensed siloxane at a silyl group on an organic segment component.

Here, a hindered amine group denotes a group or its derivative in which an amine compound have steric hindrance characteristics in the neighborhood of the N atom of the amino group. As a group having steric hindrance characteristics, a branching alkyl group or a group having carbon number of 3 or more is preferably used.

A hindered phenol group represents a group or its derivative having a group exhibiting steric hindrance characteristics in an ort position against a hydroxyl group of phenol (wherein the hydroxyl group may be modified to an alcoxyl group). As a group having steric hindrance characteristics, a branching alkyl group or a group having carbon number of 3 or more is preferably used.

A hindered amine or a hindered phenol is introduced as a partial structure into an organic segment component by the following method:
(i) a hindered amine compound (monomer) having a polymerizable unsaturated group containing a unsaturated bond of carbon atoms is coexisted in materials to form an organic segment component; (ii) the hindered amine compound is co-reacted in a polymerizing reaction of a chain polymerizable monomer (a chain polymerizable monomers of an organic segment component)in a forming step of an organic segment component.

As a hindered amine compound, a sterically hindered amine having polymerizable unsaturated group is preferably used. Specifically, an sterically hindered piperidine compound having polymerizable unsaturated group (hereinafter it is called as “piperidine type monomer”) is used. As a typical example of a piperidine type compound, a compound of Formula (A) may be given.

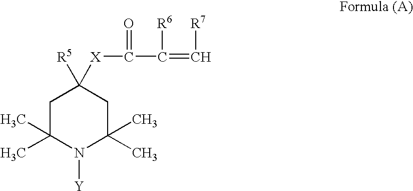

In Formula (A), R⁵ represents hydrogen atom or cyano group, R⁶ and R⁷ may be same or different and represent hydrogen atom, methyl group or ethyl group, X represents oxygen atom or imino group and Y represents hydrogen atom, alkyl group of carbon number 1-18 or polymerizable unsaturated group expressed as following Formula (B).

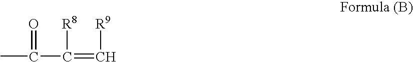

In Formula (B), R⁸ and R⁹ may be same or different and represent hydrogen atom, methyl group or ethyl group.

In Formula (A), hydrogen atom of in the imino group X may be substituted or not substituted. Examples of alkyl group having carbon number of 1-18 in Y of Formula (A) include, normal or branched chain alkyl group such as: methyl group, ethyl group, n-propyl group, isopropyl group, n-butyl group, isobutyl group, sec-butyl group, t-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl and n-octadecyl group.

Preferable examples of piperidine compound in Formula (A) include, such as:
4-(mete)acryloyloxy-2,2,6,6-tetramethylpiperidine,
4-(meth)acryloylamino-2,2,6,6-tetramethylpiperidine,
4-(meth)acryloyloxy-1,2,2,6,6-pentamethyl piperidine,
4-(meth)acryloyl amino-1,2,2,6,6-pentamethyl piperidine,
4-cyano-4-(meth)acryloyloxy-2,2,6,6-tetramethylpiperidine,
4-cyano-4-(meth)acryloyl amino-2,2,6,6-tetramethylpiperidine,
4-cyano-4-(meth)acryloyloxy-1,2,2,6,6-pentamethyl piperidine,
4-cyano-4-(meth)acryloyl amino-1,2,2,6,6-pentamethyl piperidine,
1-(meth)acryloyl-4-(meth) acryloyloxy-2,2,6,6-tetramethylpiperidine,
1-(meth)acryloyl-4-(meth)acryloyl amino-2,2,6,6-tetramethyl piperidine,
1-(meth)acryloyl-4-cyano-4-(meth)acryloyloxy-2,2,6,6-tetramethylpiperidine,
1-(meth)acryloyl-4-cyano-4-(meth)acryloyl amino-2,2,6,6-tetramethylpiperidine,
4-crotonoyloxy-2,2,6,6-tetramethylpiperidine,
4-crotonoyl amino-2,2,6,6-tetramethylpiperidine,
4-crotonoyloxy-1,2,2,6,6-pentamethyl piperidine,
4-crotonoyl amino-1,2,2,6,6-pentamethyl piperidine,
4-cyano-crotonoyloxy-2,2,6,6-tetramethylpiperidine,
4-cyano-crotonoyl amino-2,2,6,6-tetramethylpiperidine,
1-crotonoyl-4-crotonoyloxy-2,2,6,6-tetramethylpiperidine
1-crotonoyl-4-crotonoyl amino-2,2,6,6-tetramethylpiperidine,
1-crotonoyl-4-cyano-4-crotonoyloxy-2,2,6,6-tetramethylpiperidine and
1-crotonoyl-4-cyano-4-crotonoyl amino-2,2,6,6-tetramethylpiperidine.
Among these compounds, 4-(mete)acryloyloxy-2,2,6,6-tetramethylpiperidine and 4-(meth)acryloyloxy-1,2,2,6,6-pentamethyl piperidine are specifically preferable.

Alternatively, a hindered phenol compound used in the present invention preferably contain a polymerizable unsaturated group. Preferable examples include, such as:
2-t-butyl-6-(3-t-butyl-2-hydroxy-5-methylbenzyl)-4-methylphenyl acrylate,
2-(3,5-di-t-butyl-4-hydroxyphenyl)ethylacrylate,
2-(3,5-di-s-propyl-4-hydroxyphenyl)ethylacrylate,
2-(3,5-di-t-octyl-4-hydroxyphenyl)ethylacrylate,
2-(3-t-butyl-5-(3-t-butyl-2-hydroxy-5-methylbenzyl)-4-hydroxyphenyl)ethylacrylate,
2-t-butyl-6-(3-t-butyl-2-hydroxy-5-methylbenzyl)-4-methylphenyl(meth)acrylate,
2-(3,5-di-t-butyl-4-hydroxyphenyl)ethyl(meth)acrylate,
2-(3,5-di-s-propyl-4-hydroxyphenyl)ethyl(meth)acrylate,
2-(3,5-di-t-octyl-4-hydroxyphenyl)ethyl(meth)acrylate,
2-(3-t-butyl-5-(3-t-butyl-2-hydroxy-5-methylbenzyl)-4-hydroxyphenyl)ethyl(meth)acrylate,
3,5-di-t-butyl-4-hydroxyphenyl propionic acid vinylester,
3,5-di-t-octyl-4-hydroxyphenyl propionic acid vinylester,
3,5-di-t-butyl-4-hydroxyphenyl propionic acid-isopropenylester, and
3,5-di-t-octyl-4-hydroxyphenyl propionic acid-isopropenyl ester.

Examples of a compound which does not have the above mentioned hindered amine type or hindered phenol type antioxidation stractural component (compound having a polymerizable unsaturated group) include, such as:

(i) salicylicit acid type compounds, for example, phenyl salicylic acid (meth) acrylate, t-butylphenyl salicylic acid (meth) acrylate;

(ii) benzophenone-type compounds, for example:
2-(meth)acryloyloxy-4-methoxy benzophenone,
2-(meth)acryloyloxy-2′-hydroxy-4-methoxy benzophenone,
2,2′-di(meth)acryloyloxy-4-methoxy benzophenone,
2,2′-di(meth)acryloyloxy-4,4′-dimethoxybenzophenone,
2-(meth)acryloyloxy-4-methoxy-2′-carboxy benzophenone,
2-hydroxy-4-[3-(meth)acryloyloxy-2-hydroxypropoxy]benzophenone, and 2,2-dihydroxy-4-[3-(meth)acryloyloxy-2-hydroxypropoxy]benzophenone;

(iii) benzotriazole type compounds, for example:
2-[2′-(meth)acryloyloxy-5′-methylphenyl]benzotriazole,
2-[2′-(meth)acryloyloxy-5′-t-octylphenyl]benzotriazole, and
2-[2′-(meth)acryloyloxy-3′,5′-di-t-butylphenyl]benzotriazole; and

(iv) compounds, for example:
2-ethylhexyl-2-cyano-3,3-diphenyl(meth)acrylate,
1,3-bis(4-benzoyl-3-hydroxyphenoxy)-2-propyl(meth)acrylate, and 3,3-ethyl-2-cyano-3,3-diphenyl(meth)acrylate.
In the present invention, the above mentioned compound having antioxidation stractural component may be used alone or in combinations of two or more compounds. The expression “having hindered amine group or hindered phenol group” represents at least one of hindered amine group or hindered phenol group is contained in the compound, however, both of them may also be contained in the compound.

Here, an example of synthesis of an organic segment component having hindered amine group or hindered phenol group, and being silyl modified (having silyl group) will be described.

(Example of synthesizing a solution for organic segment component A: silyl modified vinyl type polymer solution A containing hindered amine group)

(i) 25 parts of γ-methacryloyloxy propyl trimethoxysilane as a monomer, 1 part of 4-methacryloyloxy-1,2,2,6,6-pentamethyl piperidine, 80 parts of methyl methacrylate, 15 parts of 2-ethylhexyl methacrylate, 29 parts of n-butylacrylate, 150 parts of 2-propanol, 50 parts of 2-butanone and 25 parts of methanol are mounted in a reaction vessel having a reflux condenser and a stirrer;

(ii) the mixture is heated up to 80° C. while stirring;

(iii) 4 parts of azobisisovaleronitrole is dissolved in 10 parts of xylene and the resulting solution is dropped in 30 minuits into the mixture;

(iv) the mixture is kept for 5 hours at 80 C to form a vinyl type polymer solution A having a solid concentration 40 percent, in which the polymer has a hindered amine group in a side-chain together with a silyl group.

(Example of synthesizing a solution for organic segment component B: silyl modified vinyl type polymer solution B containing hindered phenoll group)

(i) 20 parts of γ-methacryloyloxy propyl trimethoxysilane as a monomer, 2 parts of 2-t-butyl-6-(3-t-butyl-2-hydroxy-5-methylbenzyl)-4-methylphenyl acrylate, 70 parts of methyl methacrylate, 40 parts of n-butylacrylate, 5 parts of acrylic acid, 13 parts of 2-hydroxyethyl methacrylate, 1 part of 1,1,1-trimethylamine methacryl imide, 150 parts of 2-propanol, 50 parts of 2-butanone and 25 parts of methanol are mounted in a reaction vessel having a reflux condenser and a stirrer;

(ii) the mixture is heated up to 80° C. while stirring;

(iii) 4 parts of azobisisovaleronitrile is dissolved in 10 parts of xylene and the resulting solution is dropped in 30 minuits into the mixture;

(iv) the mixture is kept for 5 hours at 80 C to form a vinyl type polymer solution B having a solid concentration 40 percent, in which the polymer has a hindered phenol group in a side-chain together with a silyl group.

As described in the above synthesis examples A and B, an organic segment component having a hindered amine group or a hindered phenol group in a side-chain together with a silyl group is synthesized by co-existing and co-polymerizing hindered amine compound, hindered phenol compound, polymerizable silane compound and vinyl type chain polymerizable monmer.

Degree of polymerization of an organic segment component having the above described silyl group is not specifically limited, however, it is preferably 100-500.

An under coat layer having a resin structure of the present invention is formed by introducing a condensed siloxane component into the above mentioned vinyl type polymers A and B having the above mentioned silyl group. Namely, a condensed siloxame component is formed on a silyl group of a vinyl type polymer having a silyl group using the above mentioned vinyl type polymer having a silyl group and an organic silicon compound described in the following. A forming reaction of a condensed siloxane component may be carried out simultaneously with a forming reaction of an under coat layer, or, alternatively, an siloxane component may be formed on an end of a silyl group preliminarily in an under coat layer forming solution, followed by forming an under coat layer.

A condensed siloxane component has a structure in which plurality of siloxane bonds are three-dimensionally linking. This structure is represented by above mentioned Formula (2) and exhibit a resin structure obtained by polycondensation of reactive organosilicon compound.

Concrete compounds to be used for forming the condensed siloxane component are similar to the above mentioned reactive organosilicon compounds.

When two or more kinds of reactive organosilicon compounds of Formula (2) are used, R in Formula (2) of each organosilicon compound may be same or different. Photoreceptor

Charge Generating Layer

A charge generating layer contains a charge generating material (CGM). In addition, the charge generating layer may contain a binder resin and other additives as necessary.

In the photoreceptor of the present invention, phthalocyanine pigment, azo pigment, perylene pigment, azulenium pigment may be preferably used as a charge generating material. These pigments may be used alone or in combination of 2 or more kinds.

A binder can be employed in the charge generation layer as a dispersing medium of the CGM. The most preferable resin usable as the binder are formal resins, butyral resins, silicone resins, silicone-modified butyral resins, and phenoxy resins. The ratio of the charge generation material to the binder is preferably from 20 to 600 parts by weight to 100 parts by weight of the binder resin. The remaining potential accompanied with repeating use can be minimized by the use of these resins The thickness of the charge generation layer is preferably 0.1-2 μm.

Charge Transporting Layer

In the photoreceptor of the present invention, an amount of a group contributing in charge transportation (charge transport group) per unit volume is preferably increased in a charge transporting layer. It is preferable to use a charge transporting material having a smaller molecular weight per one charge transport group to increase the amount of a charge transport group per unit volume.

As a binder resin of a charge transporting layer, one with a small dielectric constant is preferably used. Examples include polystyrene resins and styrene-butadiene copolymers.

A charge transporting layer may contain additives such as an antioxidation agent as necessary. As a binder resin to be used in the charge transporting layer (CTL), although either a thermoplastic resin or a thermosetting resin may be used, a binder resin with a small dielectric constant is preferably used. Further, as particularly preferable binder resins, polystyrene resin, styrene-butadiene copolymer and polycarbonate are used solely or in combination.

The ratio of a binder resin to a charge transporting material is preferably 50-200 weight parts of charge transporting material to 100 weight parts of binder resin.

The charge transporting layer may contain a plurality of charge transporting layers. In that case the sum of the charge transporting layers may satisfy the condition that the changing rate of the exposure energy change (E_{600/100})ₙ is not larger than 0.01 (μJ/(cm²·μm)) when a thickness of the charge transporting layer n decreases from 20 μm to 15 μm and when surface potential of the organic photoreceptor varies from −600 V to −100 V.

Solvents or dispersion agents which are preferably used to form layers such as an under coat layer, a charge generating layer and a charge transporting layer are n-butylamine, diethylamide, ethylenediamine, isopropanolamine, triethanolamine, triethylenediamine, N,N-dimethylformamide, acetone, methylethylketone, methylisopropylketone, cyclohexane, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolane, dioxane, methanol, ethanol, butanol, isopropanol, ethyl acetate, butyl acetate, dimethylsulfoxide and methyl Cellosolve. Although the present invention is not limited to these, dichloromethane, 1,2-dichloroethane and methylethylketone are preferably used. These solvents can be used solely or in combination of two or more kinds.

As a coating processing method for producing an organic photoreceptor, a coating processing method such as dip coating, spray coating, or circular amount control type coating is performed, wherein spray coating or the circular amount control type coating method (represented by a circular slide hopper type) is preferably used for uniform coating in order to prevent dissolving of a lower layer when an upper layer is coated. For coating a protective layer, the circular amount control type coating method is most preferably used. The aforesaid circular amount control type coating is described in JP-A 58-189061 in detail.

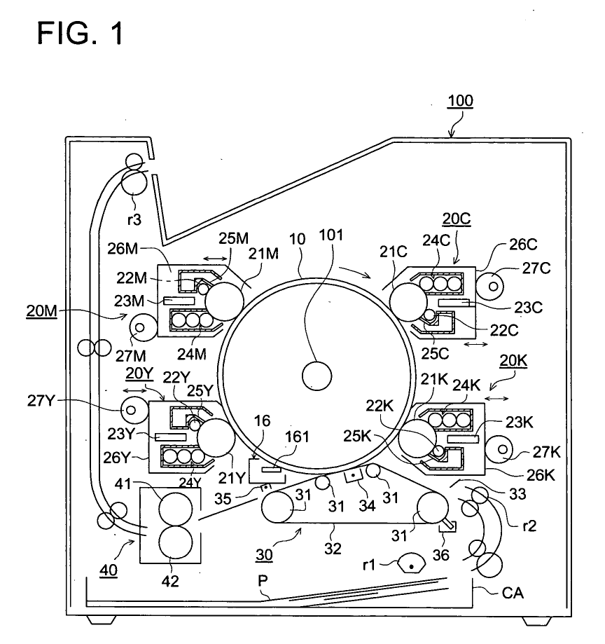

FIG. 1 is a cross-sectional construction diagram showing an example of an image forming apparatus of a tandem intermediate transfer system.

This example shows an image forming apparatus having a drum type intermediate transfer device in which a color image is formed by superimposing color toner images on transfer device 10, followed by and transferring the color image onto recording sheet P which is a recording material (for example, plain paper, transparent sheet).

Transfer device 10 sequentially superimposes and holds yellow (Y), magenta (M), cyan (C), and black (K) toner images formed by four image forming units 20Y, 20M, 20C, and 20K which are disposed around the transfer device 10. The transfer device 10 is a dram shaped transfer member which is provided with conductive rubber layer 12 (an urethane rubber layer with a thickness of 500 to 5000 μm and an electrical resistance of 10⁸ to 10¹⁴ Ω·cm) as an elastic layer and a separative film 13 (a Teflon (R) layer for separation with a thickness of 20 to 200 μm and an electrical resistance of 10¹⁰ to 10¹⁶ Ω·cm) on aluminum support member 11 which is a cylindrical metal support member. Around the transfer member 10, there are disposed the four image forming units 20Y, 20M, 20C, and 20K, recording sheet transfer device 30, and cleaning device 16. The transfer member 10 is supported by shaft 101 rotatably with respect to color image forming apparatus 100.

The four image forming units 20Y, 20M, 20C, and 20K are provided in respective frames 26Y, 26M, 26C, and 26K, the frames 26Y, 26M, 26C, and 26K being movably arranged in the color image forming apparatus 100; and there are provided moving members 27Y, 27M, 27C, and 27K for moving the respective image forming units to an image transfer position or a non image forming position, according to a color to be used, with respect to the drum-shaped transfer member 10, wherein the moving members are arranged to be in contact with the respective frames 26Y, 26M, 26C, and 26K.

The four image forming units 20Y, 20M, 20C, and 20K are respectively comprised of photoreceptor drams 21Y, 21M, 21C, and 21K, and around the respective photoreceptor drams, rotatable charging members 22Y, 22M, 22C, and 22K, image-wise exposure members 23Y, 23M, 23C, and 23K, rotatable developing members 24Y, 24M, 24C, and 24K, and cleaning members 25Y, 25M, 25C, and 25K for cleaning the respective photoreceptor drums 21Y, 21M, 21C, and 21K.

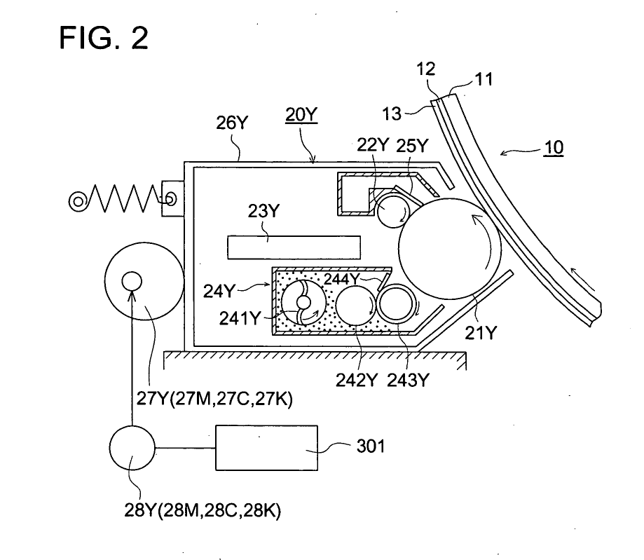

The image forming units 20Y, 20M, 20C, and 20K have the same structure except that the colors of toner images are different, which will be explained below in detail using FIG. 2 (a cross-sectional construction diagram of an image forming unit to be used in the image forming apparatus of the present invention), using the case of the image forming unit 20Y.

In the image forming unit 20Y being provided in the frame 26Y, around the photoreceptor drum 21Y which is an image forming member, there are disposed the image forming member charging member 22Y (hereinafter, referred to merely as charging member 22Y or charger 22Y), the exposure member 23Y, the developing member 24Y, and the image forming member cleaning member 25Y (hereinafter referred to merely as cleaning member 25Y or cleaning blade 25Y), wherein the image forming unit 20Y forms a yellow (Y) toner image on the photoreceptor drum 21Y. In the present embodiment, the image forming unit 20Y is arranged such that the photoreceptor drum 21Y, the charging member 22Y, the developing member 24Y, and the cleaning member 25Y, at least, are integrally provided therein.

The charging member 22Y is a means for applying a uniform electric potential to the photoreceptor drum 21Y. In the present embodiment, charger 22Y in use has a roller shape, and comes in contact with and is rotated by the photoreceptor drum 21Y.

According to an image signal (yellow), the exposure member 23Y exposes light on the photoreceptor drum 21Y that is given a uniform potential by the roller shaped charger 22Y, and thereby forms an electrostatic latent image that corresponds to a yellow image. As the exposure member 23Y, there is used (i) a device that is comprised of an LED in which luminous devices are disposed in an array in the axial direction of the photoreceptor 21Y and an image forming device (Brand name: Selfoclens), or (ii) a laser optical system.

The image forming method of the present invention is characterized by using a exposure beam for image-wise exposure having a spot area of not more than 2000 μm² in a process of electrostatic latent image formation. The photoreceptor of the present invention enables precisely forming a image corresponding to the above small spot size. The spot size is more preferably 100-800 μm². As a result, an electrophotographic image having a high tonal resolution and a resolution of more than 800 dpi (dpi represents a number of dot per 2.54 cm) can be formed.

The spot area of the exposure light beam means the area corresponding to the region in which light intensity is not smaller than 1/e² of a maximum peak intensity on a light intensity distribution plane that appears on a cross-section which is obtained by cutting the exposure light beam with a plane vertical to the beam.

For a light beam to be used, for example, scanning optical system employing a semiconductor laser, a solid scanner of LED or a liquid crystal shutter can be applied. Gauss distribution or Lorenz distribution can be applied as a light intensity distribution, wherein a spot area is defined by a region in which the light intensity is not smaller than 1/e² of the respective peak intensity.

The developing member 24Y is a device for storing a yellow toner, which is a developing agent, and conducting reversal development of an electrostatic latent image formed on the photoreceptor drum 21Y to form a yellow toner image. In the developing member 24Y of the present embodiment, the yellow toner stored in the developing member 24Y is stirred with stirring member 241Y, and then is supplied to developing sleeve 243Y by toner supply roller 242Y which has an elastic surface (sponge) and rotates in the arrow direction, wherein the yellow toner on the developing sleeve 243Y is formed into an uniform thin layer by thin layer forming member 244Y. For the developing action by the developing member 24Y, a direct-current developing bias or one further added with an alternating current is applied to the developing sleeve 243Y rotating in the arrow direction; jumping development is performed by a component stored by the developing member 24Y; a bias in which a direct current component and an alternating current component of the same polarity as that of the toner are superimposed is applied to the grounded photoreceptor 21Y; and thus non-contact reverse development is performed. Incidentally, stopper rollers provided at both ends, outside of the image region, of the developing sleeve 243Y touch the photoreceptor drum 21Y so that the developing sleeve 243Y and the photoreceptor drum 21Y are maintained to have no contact with each other. Alternatively, contact development may be applied instead of non-contact development.

The yellow toner image formed on the photoreceptor drum 21Y is sequentially transferred onto transfer member 10 to which a bias voltage with a polarity opposite to that of the toner is applied, while stopper rollers are rotating in contact with a position determination section of the transfer member 10.

The cleaning member 25Y is a device for removing residual yellow toner on the photoreceptor drum 21Y after the yellow toner image is transferred onto the transfer member 10. In the present embodiment, the residual toner is removed when the cleaning member 25Y rubs on the photoreceptor drum 21Y.

In such a manner, the yellow toner image, which corresponds to an image signal (yellow), formed by the image forming unit 20Y through charging, exposure, and development processes, is transferred onto the transfer member 10.

As shown in FIG. 1, also in the other image forming units 20M, 20C, and 20K, a magenta toner image corresponding to an image signal (magenta), a cyan toner image corresponding to an image signal (cyan), and a black toner image corresponding to an image signal (K) are likewise formed on the respective photoreceptor drums 21M, 21C, and 21K in parallel and in synchronization. The toner images formed on the respective photoreceptor drums 21Y, 21M, 21C, and 21K of the image forming units 20Y, 20M, 20C, and 20K by this operation, are sequentially transferred onto the transfer member 10 to which a transfer bias in the range from 1 to 2 kV has been applied, thus the toner images are superimposed. When all the toner images are superimposed, a color toner image is formed on the transfer member 10.

On the other hand, sheet feeding cassette CA, which is a recording material storing device, is provided below the transfer member 10. Recording sheet P, which is a recording material stored in the sheet feeding cassette CA, is taken out of the sheet feeding cassette CA by operation of sheet feeding roller r1, and conveyed to a pair of timing rollers r2. The paired timing rollers r2 feed out the recording sheet P in synchronization with the color toner image formed on the transfer member 10.

The color toner image formed on the transfer member 10 is transferred by recording sheet transfer device 30 at a transfer position onto the recording sheet P thus fed out. The recording sheet transfer device 30 is comprised of grounded roller 31, transfer belt 32, paper charger 33, transfer electrode 34, and paper sheet separating AC neutralizer 35.

The recording sheet P thus fed out is trained about rollers 31, and conveyed to the transfer position by the transfer belt 32 rotating in the arrow direction in synchronization with the circumferential velocity of the transfer member 10. The transfer belt 32 is a belt-shaped one having a high resistance in the range from 10⁶ to 10¹⁰ Ω˜cm. In this operation, the recording sheet P is paper-charged to be of the same polarity as the toner by the paper charger 33 as a recording material charging device, and is absorbed by the transfer belt 32 to be conveyed to the transfer position. By paper-charging the recording sheet P to the same polarity as that of the toner, the recording sheet P and the color toner image on the transfer member 10 are prevented from attracting each other, thereby preventing degradation of the color toner image. As the recording material charging device, there is used an energizing roller or a brush charger which is attachable and detachable to and from the transfer belt 32.

The color toner image on the transfer member 10 is transferred onto the recording sheet P by the transfer electrode 34 at the transfer position. By this transfer electrode 34, a corona discharge is applied to the rear side of the recording sheet P so that the electric potential thereof becomes in the range from 1.5 to 3 kV, which is higher than that of the bias of the transfer member 10 and of a polarity opposite to that of the toner.

The recording sheet P, onto which the color toner image has been transferred, is further conveyed by the transfer belt 32, then, is neutralized by the paper sheet separating AC neutralizer 35 for separating recording materials, and is separated from the transfer belt 32 to be conveyed to fixing device 40. In the fixing device 40, the color toner image is heated and pressed by heat roller 41 and pressure roller 42, thus fused and fixed on the recording sheet P, and then, the recording sheet P is ejected by paired sheet ejection rollers r3 onto a tray provided on an upper part of the color image forming apparatus.

On the other hand, the transfer member 10 from which the color toner image has been transferred to the recording sheet P is slidingly rubbed by cleaning blade 161 of transfer member cleaning device 16, and thus, residual toner on the transfer member 10 is removed for cleaning. A blade of transfer belt cleaning device 36 slidingly contacts with the transfer belt 32 to clean the transfer belt 32 after the separation of the printing sheet.

Although the image forming unit shown in FIG. 2 is arranged to be a process cartridge which can attach and detach the developing member and the photoreceptor drum to and from the image forming unit, a process cartridge of the present invention is not limited to this, and any process cartridge can be employed as long as the process cartridge includes at least one of a photoreceptor, a charging member, an image exposure member, a developing member, a transfer member, a separation member, and a cleaning member.

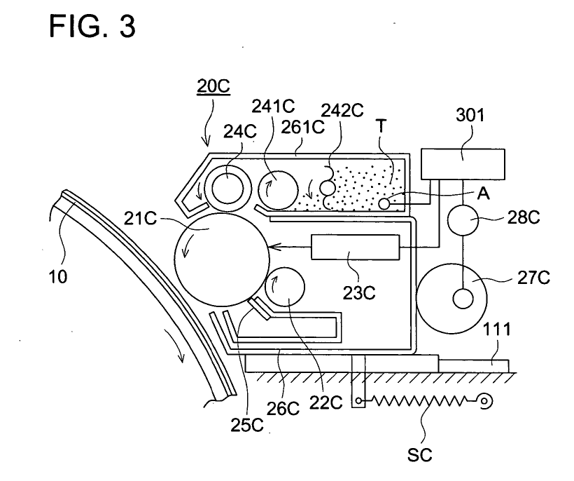

FIG. 3 is a cross-sectional construction diagram showing another example of an image forming unit to be used in an image forming apparatus of the present invention. FIG. 3 is a cross-sectional view of the image forming unit having a different structure from that of the image forming unit, shown in FIG. 2, and including a process cartridge that allows a developing member and a photoreceptor drum to attach and detach to and from the image forming unit.

The present embodiment will be described using the case of the structure of image forming unit 20C. Frame 26C constructing the image forming unit 20C is arranged at guide member 111 that is provided in the color image forming apparatus, and moving member 27C of a cam structure is arranged in contact with a part of the frame 26C, wherein the moving member 27C is stopping the image forming unit 20C together with the frame 26C at a predetermined image forming position against spring SC. In the frame 26C, charging member 22C and exposure member 23C are disposed around photoreceptor drum 21 that is an image forming member; and in second frame 261C serving as a replaceable process cartridge arranged to be attachable and detachable to and from the frame 26C, developing member 24C, developing agent supply member 241C, and developing agent stirring member 242C are provided, wherein the developing member 24C is disposed facing around the photoreceptor drum 21C.

Further, the second frame 261C stores a cyan (C) toner of a monocomponent developing agent T, and a developing agent remaining amount detecting device A for detecting the remaining amount of the monocomponent developing agent is arranged in the developing member 24C.

A cyan (C) toner image is formed on the photoreceptor drum 21C by the image forming process, and the cyan (C) toner image is transferred from the photoreceptor drum 21C to the transfer member 10 in the same way as described before, wherein cleaning member 25C is disposed to clean a surface of the photoreceptor 21C after the transfer of the cyan (C) toner image.

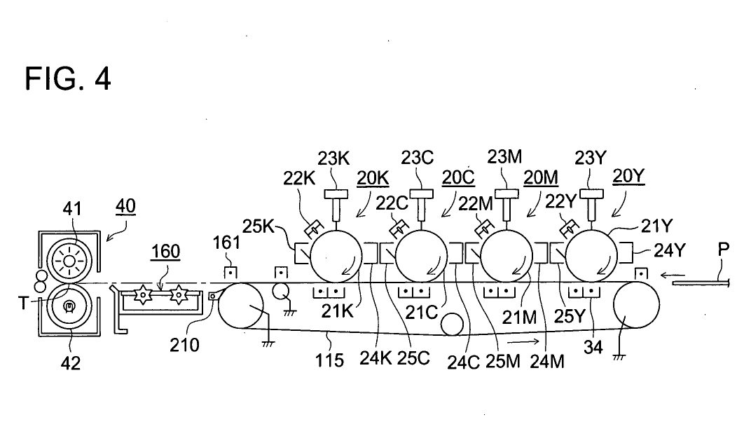

FIG. 4 is a cross-sectional construction diagram of another example of an image forming apparatus of the present invention. FIG. 4 shows an image forming apparatus that performs direct transfer onto a recording material on a transfer belt. The image forming procedure in FIG. 4 is almost the same as that in FIGS. 1 to 3, except that transfer is performed directly on the recording material instead of an intermediate transfer member.

The image forming apparatus, in FIG. 4, that performs direct transfer onto the recording material on the transfer belt will be described. FIG. 4 shows an example of color image forming by a tandem color image forming apparatus in which four photoreceptors are disposed in parallel and toner images in four colors of yellow (Y), magenta (M), cyan (C), and black (K) are sequentially transferred.

In FIG. 4, there are provided image forming units 20Y (20M, 20C, and 20K), for Y, M, C, and K, that are comprised of photoreceptor drums 21Y (21M, 21C, and 21K), scorotron chargers (charging member) 22Y (22M, 22C, and 22K), exposure optical systems (exposure members), developing members 24Y (24M, 24C, and 24K), and cleaning members 25Y (25M, 25C, and 25K). Respective toner images formed by the image forming units of Y, M, C, and K are sequentially transferred by transfer devices 34Y (34M, 34C, and 34K) with a synchronized feeding of a recording material (recording sheet P) to be formed into a superimposed color toner image.

The recording sheet is conveyed by conveyor belt 115, and separated from the conveyor belt by neutralizing operation of paper sheet separating AC neutralizer 162 serving as a recording material separating device and by separating claw 210 that is a separating member arranged with a predetermined gap from the conveyor section 160.

Further, the recording sheet P is passed through the conveyor section 160, thereafter, conveyed to fixing device 40 that is comprised of heat roller 41 and pressure roller 42, sandwiched by nip section T formed by the heat roller 41 and the pressure roller 42, then the superimposed toner image is fixed on the recording sheet P by applied heat and pressure, and thereafter the recording sheet P is ejected outside the apparatus.

<Developer>

The developer of the present invention is a double component developer in which a toner and a carrier is mixed.

As a carrier used in a double component developer, magnetic particles well known in the art may be preferably used. Examples of the magnetic particles include, iron, ferrite, magnetite and alloys of these materials with metals such as aluminum and lead. Ferrite particles are specifically preferred. The volume average diameter of said magnetic particles is preferably from 15 to 100 μm, and is more preferably from 25 to 60 μm.

The volume average particle diameter of said carrier can be determined employing a representative apparatus such as a laser diffraction type size distribution measurement apparatus “HELOS” (manufactured by Sympatec Co.) provided with a wet type homogenizer.

Preferred as said carrier are carriers comprised of magnetic particles further coated with resins, and a so-called resin dispersion type carrier prepared by dispersing magnetic particles into resins. Resin compositions for coating are not specifically limited. For example, employed may be olefin based resins, styrene based resins, styrene-acryl based resins, silicone based resins, ester based resins, or fluorine-containing polymer based resins. Further, resins for constituting said resin dispersion type carrier are also not specifically limited, and any of the several known in the art can be employed. For example, styrene-acryl based resins, polyester resins, fluorine based resins, and phenol resins are preferably used.

The toner used in the present invention may be prepared by a pulverization method or by a polymerization method, and the toner is preferably uniform in shape factor and in particle size distribution as described below. Namely, in the present invention, a sharp electrophotographic image with high tonal resolution can be obtained by employing an image forming method in which toners having a uniform shape factor and a uniform particle size distribution are simultaneously used.

(1) Toner containing not less than 65 percent by number of particles exhibiting a shape factor of 1.2-1.6:

When a shape factor of a toner is smaller than 1.2, the shape of the toner particles becomes closer to a sphere, and an adhesive strength of toner to a photoreceptor increases. As a result, cleaning failure tends to increase. On the other hand, when the shape factor is larger than 1.6, the toner particles become easer to be pulverized forming minute particles, and again, cleaning failure increases. Therefore, a toner containing particles of a shape factor of 1.2-1.6 not less than 65 percent by number, or more preferably not less than 70 percent by number is favorable in reducing cleaning failure while preventing pulverization of particles. Use of this toner with a photoreceptor of the present invention enables formation of fine images and a favorable cleaning property for a long time.

(2) Toner having not less than 50 percent by number of toner particles without a corner:

Toner particles without a corner denote toner particles substantially having no sharp edges where concentration of electric charge or pulverization by means of stress occurs. Use of a toner having not less than 50 percent by number or, more preferably, not less than 70 percent by number of toner particles without a corner reduces formation of minute particles due to a stress caused by contacting with a developing agent conveyer member resulting in preventing cleaning failure due to minute toner particles. Use of this toner with a photoreceptor of the present invention enables formation of fine images and a favorable cleaning property for a long term. The ratio of toner particles without a corner in a toner is preferably not less than 50 percent by number, and more preferably not less than 70 percent by number.

(3) Regarding the particle size distribution of the toner, it is preferable that the sum M of the relative frequency m₁ of toner particles included in the highest frequent class and the relative frequency of the toner particles m₂ included in the next frequent class is not less than 70% in a histogram showing the distribution of number based particle diameter classified in to plural classes at intervals of 0.23 on the horizontal axis of natural logarithm 1 nD, D is the diameter of the toner particle in μm.

In the toner in which the sum of the relative frequency m₁ and the relative frequency m₂ is not less than 70%, a sharp distribution of the toner particle size is obtained resulting in a formation of a stabilized toner image. As a result, use of this toner with a photoreceptor of the present invention enables formation of fine images and a favorable cleaning property for a long time.

(4) A toner exhibiting a number variation coefficient in number particle size distribution is 27% or less and a variation coefficient of the shape factor is 16% or less:

By using a toner exhibiting a number variation coefficient in number particle size distribution is 27% or less and a variation coefficient of the shape factor is 16% or less, an excellent cleaning property and high quality images exhibiting a superior minute line reproducibility are obtained for a long time.

The number variation coefficient in number particle size distribution is preferably 27% or less, more preferably 25% or less and further more preferably 14% or less. Use of such a toner results in a sharp shape distribution of toner particles and by using this toner with the photoreceptor of the present invention, an excellent cleaning property and high quality images are obtained for a long time.

A toner of which the variation coefficient of the shape factor is 16% or less and containing 65% or more of toner particles of which the shape factor is in a range of 1.2-1.6 is preferably used. This toner shows a smaller adhesive force to a photoreceptor and an excellent cleaning property.

Also, by use of a toner containing 50% or more of toner particles without a corner, an excellent cleaning property and high quality images exhibiting a superior minute line reproducibility are obtained for a long time.

The particle size of the toner according to the present invention is preferably 3-8 μm in the number average particle diameter. When the toner particles are prepared by a polymerization method, the particle diameter can be controlled according to the concentration of the aggregating agent, the adding amount of the organic solvent, the time for aggregation and the composition of the resin it self.

When the number average diameter of the toner particles is in a range of 3-8 μm, number of minute toner particles having too high or too low adhesion force to a developing agent conveyer member becomes smaller, and a long term stabilization of developing property is obtained. As a result, increase in qualities of halftone, fine line and dot due to an increased transferring efficiency of the toner.

In the present invention, a shape factor of toner is expressed by the following expression, and it shows a degree of sphericity of a toner particle.
Shape factor=((maximum diameter/2)2×π)/Projective area

Herein, the maximum diameter in this case means the maximum width of two parallel lines when a projected image of the toner-particle on a plane is pinched with the parallel lines. Further, a projected area represents an area of the image of a toner particle projected on a plane.

In the present invention, this shape factor was obtained by the method wherein a photograph of a toner particle enlarged by 2000 times was made by the use of a scanning electron microscope, and based on this photograph, measurement was taken by analyzing the photographic image by the use of “SCANNING IMAGE ANALYZER” (made by Nihon Denshi Co.). In this case, 100 toner particles were used to measure the shape factor in the present invention by using the aforementioned calculation expression.

In a toner used in the present invention, preferable content of toner particles of which shape factor is within a range of 1.2-1.6 to be 65 number % or more, and more preferable is 70 number % or more.

A method to control the shape factor is not specifically limited. For example, available methods include (i) a method to spray toner particles in a hot air current; (ii) a method to give mechanical energy caused by impact force repeatedly to toner particles in a vapor phase; and (iii) a method to add toner in a solvent which dissolves no toner and to give circling current. In the present invention, a polymerization toner having a shape factor within the above mentioned range is preferably prepared.

A variation coefficient of a shape factor of a toner is calculated from the following expression.
Variation coefficient=(S/K)×100(%)

(In the expression, S represents a standard deviation of the shape factor of 100 toner particles, and K represents a mean value of the shape factors).

The variation coefficient of the shape factor is preferably 16% or less, and more preferably 14% or less. Owing to the variation coefficient of the shape factor which is 16% or less, porosity of the transferred toner layer is reduced and fixing property is improved, thus, occurrence of offsetting also reduced. In addition, distribution of an amount of charge becomes sharp, and image quality is improved.

To control the shape factor and the variation coefficient of the toner to be uniform without dispersion between lots, an appropriate process ending time may also be determined while monitoring characteristics of toner particles (colored particles) being formed, in the process for polymerization of resin particles (polymer particles), fusion and shape control.

Monitoring means controlling the process conditions based on the results of measurement by measuring instruments incorporated on an inline basis. Namely, in the case of polymerization toner formed through association or fusion of resin toner in aqueous medium, by incorporating measurement of shapes in inline, shapes and particle diameters are measured while sampling is conducted successively in the process of fusion, and reaction is stopped at a point of time when a desired shape is attained.

In regard to a monitoring method, it is not limited in particular, and a flow type particle image analysis equipment FPIA-2000 (made by SYSMEX Corporation) can be used. This equipment is ideal because it is possible to monitor the shape by conducting image processing on a real time basis while making a sample solution to pass through. Namely, monitoring is conducted constantly from the reaction field by using a pump, while measuring a shape, and then, the reaction is stopped when the desired shape is observed.

The number particle size distribution and a number variation coefficient of toner in the present invention are measured by Coulter counter TA-II or Coulter multisizer (made by Coulter Co.). In the present invention, Coulter multisizer was used by connecting to Interface (made by NIKKAKI) and a personal computer. As an aperture used in the Coulter multisizer, a 100 μm aperture was used, and particle size distribution and an average particle size were calculated by measuring a volume and number of toner of 2 μm or larger. Number particle size distribution is one showing the relative frequency of toner particles for particle diameter, and number average particle diameter is one showing a median diameter in the number particle size distribution.

The number variation coefficient in the number particle size distribution of toner is calculated from the following expression;
Number variation coefficient=(S/Dn)×100(%)
(wherein, S represents a standard deviation in the number particle size distribution, and Dn represents the number average particle diameter (μm)).

There is no restriction, in particular, for the method to control the number variation coefficient. For example, a method of classification in a liquid is effective for making the number variation coefficient to be small, although a method to classify toner particles with wind power can also be used. As a method for classification in a liquid, there is available a method to manufacture by separating and collecting toner particles in accordance with a difference of a sedimentation velocity caused by a difference of toner particle diameter, by using a centrifugal separator and by controlling a speed of rotation.

Specifically, when a toner is manufactured through a suspension polymerization method, classification operations are indispensable for making the number variation coefficient in the number particle size distribution to be 27% or less. In the suspension polymerization method, it is necessary to disperse polymerizable monomers in an aqueous medium to be a droplet of oil whose size is a desired one as toner, before polymerization. Namely, mechanical shearing is applied on a large-sized droplet of oil of polymerizable monomer repeatedly by a homo-mixer or a homogenizer to make the droplet of oil small approximately to the size of a toner particle. However, in the method of the mechanical shearing, the number particle size distribution of droplets of oil thus obtained is broad, and the particle size distribution of toner made by polymerizing the foregoing is also broad accordingly. Therefore, classification operations are indispensable.

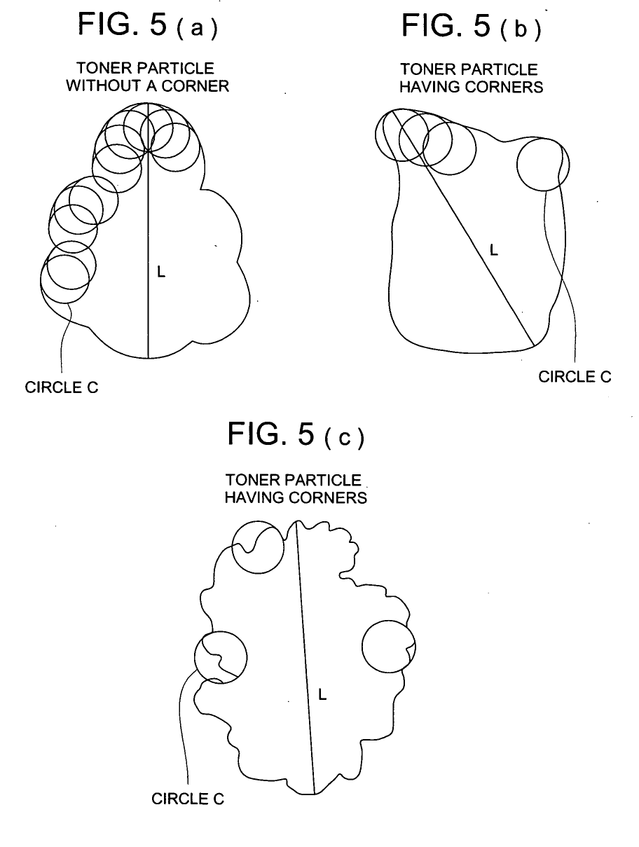

In the case of toner used in the present invention, a toner particle without a corner means a toner particle that substantially has no protrusion where electric charges are concentrated, or no protrusion that is easily worn away by stress. Namely, under the condition that L represents a major axis of toner particle T, when circle C having radius (L/10) is made to roll along a peripheral line of toner particle T while touching at one point on the inside of the peripheral line, if circle C does not protrude out of toner T substantially, as shown in FIG. 5(a), the toner particle T is called “toner particle without a corner”. “An occasion of no protruding substantially” means the case wherein the number of protrusions where the circle protrudes out is not more than one. “A major axis of toner particle” means a width of the toner particle whose projected image makes a distance between two parallel lines which pinch the projected image of the toner particle to be the maximum. Further, the projected area is an area of the image of a toner particle projected on a plane. Incidentally, each of FIG. 5(b) and FIG. 5(c) shows a projected image of a toner particle having corners.

Measurement of toner particles without a corner was conducted as follows. First, an enlarged photograph of a toner particle was obtained by the use of a scanning electron microscope, and it was further enlarged to a magnification of 15000 times. Then, this photographic image was examined in terms of existence of the corners. This measurement was conducted for 100 toner particles.

There is no restriction, in particular, for the method to obtain a toner without a corner. For example, as a method to control the shape factor, there is available, as stated above, a method to spray toner particles in a hot air current, or a method to give mechanical energy caused by impact force repeatedly to toner particles in a vapor phase, or a method to add toner in a solvent which dissolves no toner and to give circling current. With respects to production cost and energy cost, a toner produced by means of a polymerization method is preferable.

In the case of polymerization toner formed through association or fusion of resin toner, many irregularities are present on the surface of the fused particle and the surface is not smooth when the fusion is stopped, but it is possible to obtain toner particles without a corner, by adjusting conditions such as temperature, the speed of rotation of impellers and time for stirring. Though these conditions are varied depending on physical characteristics of resin particles, the surface becomes smooth and toner particles without a corner can be formed, when the temperature higher than a glass transition point of resin particles and higher speed of rotation, for example, are selected.

The number average particle diameter of the toner is preferably 3-8 μm. When forming toner particles through a polymerization method, a particle diameter can be controlled by density of coagulant, weight of added organic solvent, or polymerization time, further by composition of a polymer itself.

It is preferable that the sum M of the relative frequency m₁ of toner particles included in the highest frequent class and the relative frequency of the toner particles m₂ included in the next frequent class is not less than 70% in a histogram showing the distribution of number based particle diameter classified in to plural classes at intervals of 0.23 on the horizontal axis of natural logarithm 1 nD, D is the diameter of the toner particle in μm.

In the toner in which the sum of the relative frequency m₁ and the relative frequency m₂ is not less than 70%, since a sharp distribution of the toner particle size is obtained, an occurrence of a selective development is definitely suppressed when the toner is used in an image forming process, resulting in a formation of a stabilized toner image.

In the present invention, the histogram of the number based particle size distribution is a histogram illustrating the particle size distribution based on the particle number classified into plural classes according to every 0.23 of natural logarithm 1 nD of the diameter of the individual toner particle, namely, 0 to 0.23, 0.23 to 0.46, 0.46 to 0.69, 0.69 to 0.92, 0.92 to 1.15, 1.15 to 1.38, 1.38 to 1.61, 1.61 to 1.84, 1.84 to 2.07, 2.07 to 2.30, 2.30 to 2.53, 2.53 to 2.76 . . . . The histogram is prepared by measuring the particle diameter of the sample measured by Coulter Multisizer under the following conditions. The measured data are transferred to a computer through an I/O unit and the histogram is prepared according to a particle size distribution analyzing program by the computer.

Measuring Condition

(1) Aperture: 100 μm
(2) Sample preparation: A suitable amount of a surfactant (neutral detergent) is added to 50-100 ml of an electrolyte solution Isoton R-11, produced by Coulter Scientific Japan Co., Ltd., and stirred. Into the mixture, 10-20 mg of the sample to be measured is added and dispersed by an ultrasonic dispersing apparatus for 1 minute to prepare the sample liquid.

In the methods for controlling the shape factor, a polymerization toner is preferable in view of the following two points: (i) the manufacturing method thereof is simple and (ii) uniformity on the surface of the polymerization toner is superior to that of crushed toner.

A polymerization toner can be manufactured by, for example, a suspension polymerization method, or a method wherein a monomer is subjected to emulsion polymerization in a solution containing necessary additives to make fine grains of polymer particles, then, an organic solvent and a coagulating agent are added thereto to be associated. It is further possible to manufacture by a method wherein there are mixed a monomer and a dispersed solution of releasing agents and coloring agents both necessary for constituting toner, or a method wherein toner constituent components such as releasing agents and coloring agents are dispersed in a monomer and then they are subjected to emulsion polymerization. In this case, “association” means that a plurality of resin particles and a plurality of coloring agent particles are fused.

In an example of the method for manufacturing toner, various constituent materials such as a coloring agent and further, if necessary, a releasing agent, a charge controlling agent and a polymerization starting agent are added to a solvent of polymerizable monomer, and the various constituent materials are dissolved or dispersed in the solvent of polymerizable monomer by a homogenizer, a sand mill, a sand grinder or an ultrasonic homogenizer. The solvent of polymerizable monomer in which the various constituent materials are dissolved or dispersed is dispersed in an aqueous medium containing dispersion stabilizing agents by the use of a homo-mixer or a homogenizer, to obtain a dispersion solution containing an oil droplet having a desired size as toner. After that, the dispersion solution is put in a reaction vessel wherein a stirring mechanism is represented by a stirring blade stated later, to be heated so that polymerization reaction is advanced. After completion of the reaction, the dispersion stabilizing agents are removed, and the dispersion solution is filtered, washed and dried, to prepare toner.

Further, as a method to manufacture toner, there is given a method wherein resin particles are subjected to association or fusion in aqueous medium to manufacture toner. This method is not limited in particular, and is disclosed in, for example, JP-A 5-265252, 6-329947 and 9-15904. Namely, it is possible to manufacture toner in a method wherein a plurality of resin particles and dispersion particles of constituent materials such as coloring agents are subjected to association, and in particular, it is possible to manufacture toner by adding coagulant having critical coagulation density or higher for salting-out after dispersing in water by using an emulsifier, by heating for fusion at a glass transition point of the formed polymer itself so that fused particles may be formed while growing gradually in terms of a particle diameter, by stopping growth of the particle diameter by adding a large amount of water when the particle diameter shows the aimed value, by controlling a shape by smoothing the particle surface while heating and stirring further, and by heating and drying the particles under the flowing condition while they are in the state of containing water (salting-out/fusion).
Incidentally, a solvent that dissolves infinitely-in water may also be added simultaneously with coagulant.

Materials, manufacturing methods, reaction apparatus to produce a toner of the present invention exhibiting a uniform shape factor are described in details in JP-A 2000-214629.

### EXAMPLES

The present invention will be described in detail with example. However, the present invention is not limited thereto. Incidentally, “part” in the description represents “weight part”.

### Example 1

Preparation of Photoreceptors Groups 1-3

<Under Coat Layer (UCL)>

The following liquid coating composition was prepared and coated on a cleaned cylindrical aluminum base member with a diameter of 30 mm, by a dip coating method, to form an under coat layer.

An under coat layer having organic segment component, inorganic segment component and antioxidation stractural component of a thickness of 4.0 μm was prepared as follows:
(i) The following materials were mixed and well stirred:

Solution of Organic Segment Component A

| | |
|---|---|
| (Solution for vinyl polymer A having a hindered | 100 parts |
| amine group and being Cyril modified) | |
| Methyl trimethoxy silane | 70 parts |
| Dimethyl dimethoxy silane | 30 parts |
| Minute particles (Anatase type titanium oxide(number | 100 parts |
| average particle diameter of primary particles: 35 nm, primary | |
| surface treantment: silica-alumina treatment and secondary | |
| surface treatment: methylhydrodien poly siloxyane treatment) | |
| butyl alcohol | 100 parts |
| butylcellosolve | 75 parts |
| di-i-propoxy ethyl acetoacetate aluminum | 10 parts; |

(ii) 30 parts of pure water was added by dropping under stirring;
(iii) reacted for 4 hours at 60° C.;
(iv) after cooled to ambient temperature, 10 parts of i-propyl alcohol solution (solid content 15%) of dioctyltin dimaleate ester was dropped and further stirred;
(v) thus prepared coating solution of under coat layer was applied using a circular amount control type coating applicator on the above mentioned cylindrical aluminum support member; and
(vi) heated at 120° C. for 1 hour for hardening.

The specific resistance measured under the above described condition was 3×10¹³ Ω·cm.

<Charge Generating Layer (CGL)>

The following materials were mixed:

| | |
|---|---|
| Oxytitanylphthalocyanine (Bragg angel: 2θ of a biggest | 20 parts |
| peak in X-ray diffraction using Cu-Kα radiation is 27.3 | |
| degrees) | |
| polyvinylbutyral (# 6000-C, Denki Kagaku Kogyo | 10 parts |
| Kabushiki Kaisha) | |
| t-butyl acetate | 700 parts |
| 4-methoxy-4-methyl-2-pentanone | 300 parts |

The mixture was dispersed using a sandmill to form a coating solution of a charge generating layer. The solution was applied on the above mentioned under coat layer to form a charge generating layer of a dry thickness of 0.3 μm.
<Charge Transporting Layer>

A coating solution of a charge transporting layer was prepared by mixing and dissolving the following materials.

| | |
|---|---|
| Charge transporting material (T-1) | 200 parts |
| polycarbonate Z (dielectric constant (60 Hz): 3.1, | 300 parts |
| molecular weight 30,000) | |
| antioxidation agent (Irganox1010, product of Ciba Geigy | 6 parts |
| Japan Ltd.) | |
| dichloro methane | 2000 parts |
| silicone oil (KF-54, product of Shin-Etsu Chemical Co., | 1 part |
| Ltd.) | |

The coating solution was applied on the above mentioned charge generating layers by means of circular amount control type coating method, dried at 70° C. for 125 minutes and charge transporting layers having dry thicknesses of 20, 15 and 10 μm were prepared. Four of each group of photoreceptor group 1 (charge transporting layer thickness: 20 μm), photoreceptor group 2 (charge transporting layer thickness: 15 μm),and photoreceptor group 3 (charge transporting layer thickness: 10 μm), each having residual solvent of 100 ppm or less, were prepared, wherein the number “four” corresponds to photoreceptors of the four colors, namely, black(Bk), Y, M and C. The photoreceptors were named as, for example, photoreceptor 1Bk, photoreceptor 1Y, photoreceptor 1M and photoreceptor 1C. Simultaneously, as samples to measure a changing rate of (E_{600/100})ₙ of photoreceptor group 1, sheet type photoreceptors 1a and 1b were prepared, which have the same under coat layers, charge generating layers and charge transporting layers as the above described photoreceptors, the thicknesses of the charge transporting layers being 20 and 15 μm, respectively, on PET (polyethylene terephthalate) sheets evaporated with aluminum.

Preparation of Photoreceptor Group 4

Four photoreceptors of Photoreceptor group 4 (Photoreceptors 4Bk, 4Y, 4M and 4C) were prepared in the same manner as Photoreceptor group 1 except that the thickness of the under coat layer was 3.0 μm, the charge transporting material of the charge transporting layer was substituted for T-5 and the thickness was 18 μm. Simultaneously, as samples to measure a changing rate of (E_{600/100})ₙ, sheet type photoreceptors 4a and 4b were prepared, which have the same thicknesses of under coat layers and charge generating layers as photoreceptors group 4 and the thicknesses of charge transporting layers being 18 and 15 μm, respectively, on PET (polyethylene terephthalate) sheets evaporated with aluminum.

Preparation of Photoreceptor Group 5

Four photoreceptors of Photoreceptor group 5 (Photoreceptors 5Bk, 5Y, 5M and 5C) were prepared in the same manner as Photoreceptor group 1 except that the solution of organic segment component A (solution of silyl modified vinyl type polymer A having a hindered amine group) was substituted for the solution of organic segment component B (solution of silyl modified vinyl type polymer B having a hindered phenol group), the charge transporting material of the charge transporting layer was substituted for T-3 and the thickness was 20 μm. Simultaneously, as samples to measure a changing rate of (E_{600/100})ₙ, sheet type photoreceptors 5a and 5b were prepared, which have the same thicknesses of under coat layers, charge generating layers as Photoreceptors Group 5 and the thicknesses of charge transporting layers being 20 and 15 μm, respectively, on PET (polyethylene terephthalate) sheets evaporated with aluminum.

Preparation of Photoreceptor Group 6

Four photoreceptors of Photoreceptor group 6 (Photoreceptors 6Bk, 6Y, 6M and 6C) were prepared in the same manner as Photoreceptor group 1 except that the thickness of under coat layer was 3.0 μm and the charge transporting material of the charge transporting layer was substituted for T-6. Simultaneously, as samples to measure a changing rate of (E_{600/100})ₙ, sheet type photoreceptors 6a and 6b were prepared, which have the same thicknesses of under coat layers and charge generating layers as Photoreceptors group 6 and the thicknesses of charge transporting layers being 20 and 15 μm, respectively, on PET (polyethylene terephthalate) sheets evaporated with aluminum.

Preparation of Photoreceptor Groups 7-9

Four of each Photoreceptor group 7, 8 and 9 (for example, Photoreceptors 7Bk, 7Y, 7M and 7C) were prepared in the same manner as Photoreceptor group 1 except that the drying conditions were changed as follows.

<Under Coat Layer>

The following materials were dispersed by means of circulation type wet dispersion to form a coating solution of an under coat layer. An under coat layer of a thickness of 1.5 μm was formed by dip coating the solution.

| | |
|---|---|
| Polyamide resin (CM 8000) (product of Toray company) | 10 parts |
| Rutile-type titanium dioxide (number average particle | 30 parts |
| size of primary particles: 35 nm, primary surface treatment: | |
| silica-alumina treatment and secondary surface treatment: | |
| methylhydrodien poly siloxyane) | |
| Methanol | 100 parts |

<Charge Generating Layer (CGL)>

Charge generating layer was prepared as the same manner as Photoreceptor group 1.

<Charge Transporting Layer>

A coating solution of charge transporting layer was prepared by mixing and dissolving the following materials.

| | |
|---|---|
| Charge transporting material (Compound T-7 having a | 200 parts |
| structure shown below) | |
| Polycarbonate Y (dielectric constant (60 Hz): 3.3, | 300 parts |
| molecular weight 30,000) | |
| Antioxidation agent (Irganox1010, product of Ciba | 6 parts |
| Geigy Japan Ltd.) | |
| Dichloro methane | 2000 parts |
| Silicone oil (KF-54, product Shin-Etsu Chemical Co., | 1 part |
| Ltd.) | |

The coating solution was applied on the above mentioned charge generating layers by using a circular amount control type coating method followed by dried at 100° C. for 75 minutes to form photoreceptor group 7 of which residual solvent was 600 ppm and the dry thickness was 20 μm, photoreceptor group 8 of which residual solvent was 400 ppm and the dry thickness was 15 μm and photoreceptor group 9 of which residual solvent was 250 ppm and the dry thickness was 10 μm. Simultaneously, samples to measure a changing rate of (E_{600/100})ₙ of Photoreceptor groups 7-9, sheet type photoreceptors 7a and 7b were prepared, which have the same thicknesses of under coat layers, charge generating layers as Photoreceptors groups 7-9 and the thicknesses of charge transport layers being 20 and 15 μm, respectively, on PET (polyethylene terephthalate) sheets evaporated with aluminum. 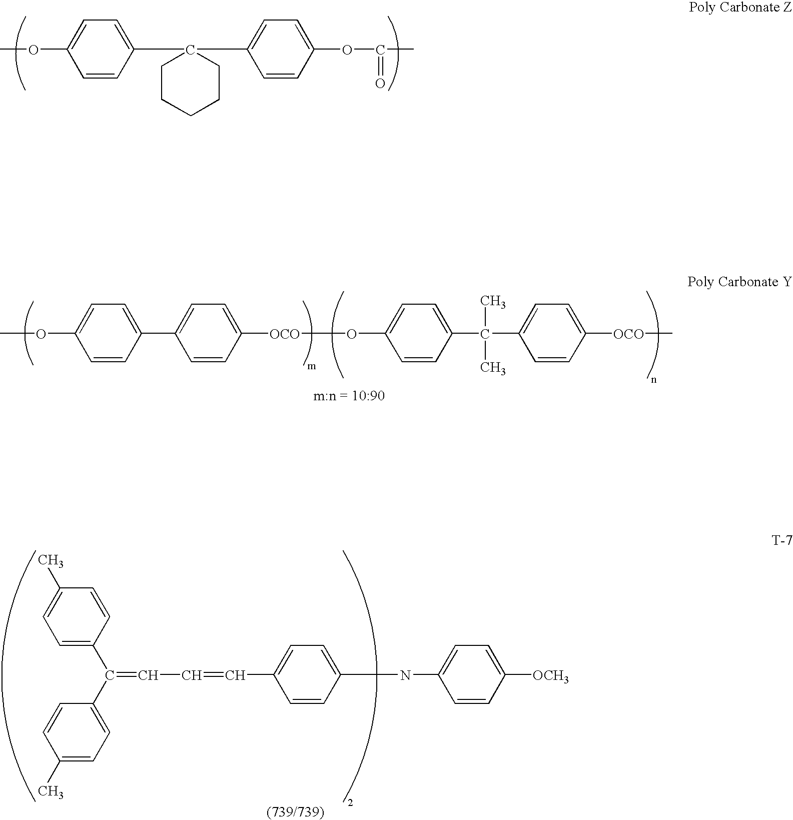
Evaluation of a changing ratio (μJ/cm²·μm) of Exposure Energy Change (E_{600/100})ₙ (sensitivity)

Using the above described sheet type photoreceptors (1a and 1b), (4a and 4b), (5a and 5b), (6a and 6b) and (7a and 7b), changing ratios of exposure energy change (sensitivity) when charging potential was varied from −600 V to −100 V were evaluated from the following equation. Evaluation of sensitivity was carried out by using CYNTHIA591K (Produced by GENTEC EO Inc.) The results are shown in Table 1.

For example, the changing ratio (μJ/cm²·μm) of exposure energy change (sensitivity) (E_{600/100})ₙ when the thickness of Photoreceptor group 1 decreases from 20 μm to 15 μm was calculated as follows using the following equation:
(changing ratio of exposure energy (μJ/cm²·μn) of Photoreceptor group 1)=(sensitivity of photoreceptor 1a−sensitivity of photoreceptor 1b)/(20−15)

When an initial thickness of a charge transporting layer of a photoreceptor is thinner than 20 μm, for example 18 μm, the changing ratio (μJ/cm²·μm) of exposure energy change per 1 μm decrease in thickness of a charge transporting layer may be calculated using sensitivities at the thicknesses of 18 μm and 15 μm.

TABLE 1

| | | | | Changing rate of |
|---|---|---|---|---|
| | | | | exposure energy |
| | Sensitivity (μJ/cm²) | | | change |
| Film Thickness (μm) | 20 | 18 | 15 | (μJ/(cm² · μm)) |
| Photoreceptor | 0.361 | — | 0.390 | 0.0060 |
| Groups 1-3 | | | | |
| Photoreceptor Group 4 | — | 0.365 | 0.388 | 0.0077 |
| Photoreceptor Group 5 | 0.358 | — | 0.385 | 0.0054 |
| Photoreceptor Group 6 | 0.342 | — | 0.388 | 0.0092 |
| Photoreceptor | 0.325 | — | 0.396 | 0.0142 |
| Groups 7-9 | | | | |

The changing ratio of exposure energy change (E_{600/100})ₙ may be evaluated using only one photoreceptor, namely, by using a sensitivity of a new photoreceptor and that of after used in which the thickness is decreased.

Toner used in the present invention and a developing agent using the toner were prepared as follows.

(Example of Toner Preparation: Association Method via Emulsion Polymerization)

Into a vessel, 0.90 kg of sodium n-dodecylsulfate and 10.0 l of purified water were charged and dissolved by stirring. To the solution, 1.20 kg of carbon black Regal 330R, produced by Cabot Co., Ltd., is gradually added and sufficiently stirred for 1 hour, and then continuously dispersed for 20 hours by a sand grinder (medium using dispersing machine). Thus obtained was referred to as Colorant Dispersion 1.

A solution composed of 0.055 kg of sodium dodecylbenzenesulfonate and 4.0 l of ion-exchanged water was prepared. The solution was referred to as Anionic Surfactant Solution A.

A solution composed of 0.014 kg of a nonylphenol polyethylene oxide adduct (10 moles adduct) and 4.0 l of ion-exchanged water was prepared. The solution was referred to as Nonionic Surfactant Solution B.

A solution composed of 223.8 g of potassium persulfate and 12.0 l of ion-exchanged water was prepared. The solution was referred to as Initiator Solution C.

Into a glass lining reaction vessel with a volume of 100 l, to which a thermal sensor, a cooler and a nitrogen gas introducing device were equipped, 3.41 kg of wax emulsion, the whole amount of Anionic Surfactant Solution A and the whole amount of Nonionic Surfactant Solution B were charged and stirred, and then 44 l of ion-exchanged water was added. The wax emulsion was emulsion polypropylene having a number average molecular weight of 3,000, the number average primary particle diameter of 120 nm and a solid component concentration of 29.9%.

The mixture was heated by 75° C. and the whole amount of Initiator Solution C was dropped into the mixture. Thereafter, 12.1 kg of styrene, 2.88 kg of n-butyl acrylate, 1.04 kg of methacrylic acid and 548 g of t-dodecylmercaptane were dropped while maintaining the temperature at 75° C.±1° C. After finish of the dropping, the temperature was raised to 80° C.±1° C. and the reacting liquid was heated and stirred for 6 hours. Then the liquid temperature was lowered by 40° C. or less and stirring was stopped. The liquid was filtered by a Poul Filter to obtain latex. The latex was referred to as Latex A.

The resin particle of Latex A had a glass transition point of 57° C., a softening point of 121° C., a weight average molecular weight of 12,700 and a weight average particle diameter of 120 nm.

A solution composed of 0.055 kg of sodium dodecylbenzenesulfonate and 4.0 l of ion-exchanged water was prepared. The solution was referred to as Anionic Surfactant Solution D.

A solution composed of 0.014 kg of a nonylphenol adduct with 10 moles of polyethylene oxide and 4.0 l of ion-exchanged water was prepared. The solution was referred to as Nonionic Surfactant Solution E.

A solution composed of 200.7 g of potassium persulfate, produced by Kanto Kagaku Co., Ltd., and 12.0 l of ion-exchanged water was prepared. The solution was referred to as Initiator Solution F.

Into a glass lining reaction vessel with a volume of 100 l, to which a thermal sensor, a cooler, a nitrogen gas introducing device and a comb-shaped baffle are equipped, 3.41 kg of wax emulsion, the whole amount of Anionic Surfactant Solution D and the whole amount of Nonionic Surfactant Solution E were charged and stirred. The wax emulsion was emulsion polypropylene having a number average molecular weight of 3,000 and the number average primary particle diameter of 120 nm and a slid component concentration of 29.9%.

And then 44.0 l of ion-exchanged water was added. The mixture liquid was heated by 70° C. and Initiator Solution F was added. Thereafter, a previously prepared mixture of 11.0 kg of styrene, a mixture of 4.00 kg of n-butyl acrylate, 1.04 kg of methacrylic acid and 9.02 g of t-dodecylmercaptane was dropped. After finish of the dropping, the liquid was continuously heated and stirred for 6 hours while maintaining the temperature at 72° C.±2° C. The temperature was further raised by 80° C.±2° C. and heated and stirred for 12 hours. Then liquid temperature was lowered by 40° C. and the stirring was stopped. The liquid was filtered by Pall Filter. Thus obtained filtrate was referred to as Latex B.

The resin particle of Latex B had a glass transition point of 58° C., a softening point of 132° C., a weight average molecular weight of 245,000 and a weight average particle diameter of 110 nm.

A solution composed of 5.36 kg of sodium chloride and 20.0 l of ion-exchanged water was prepared. The solution was referred to as Sodium Chloride Solution G.

A solution composed of 1.00 g of a fluorinated nonionic surfactant and 1.00 l of ion-exchanged water was prepared. The solution was referred to as Nonionic Surfactant Solution H.

Into a SUS reaction vessel with a volume of 100 1, to which a thermal sensor, a cooler, a nitrogen gas introducing device and an apparatus for monitoring the diameter and the shape of the particle were equipped, 20.0 kg of the above-prepared Latex A, 5.2 kg of Latex B, 0.4 kg of the colorant dispersion and 20.0 kg of ion-exchanged water were charged and stirred. The liquid was heated by 40° C. and Sodium Chloride Solution G, 6.00 kg of isopropanol, produced by Kanto Kagaku Co., Ltd., and Nonionic Surfactant Solution H were added in this order. After standing for 10 minutes, the liquid was heated by 85° C. spending for 60 minutes, and heated and stirring for 0.5 to 3 hours at 85° C.±2° C. for growing the particles by salting out and adhering by fusion (salting out/fusion-adhering process). Then 2.1 l of purified water was added to stop the particle growing. Thus a dispersion of fusion-adhered particle dispersion was prepared.

Into a 5 l reaction vessel to which a thermal sensor, a cooler and an apparatus for monitoring the diameter and the shape of the particle, 5.0 kg of the above-prepared fusion-adhered particle dispersion was charged and heated and stirred for 0.5 to 15 hours at 85° C.±2° C. for shape control (shape controlling process). Then the liquid was cooled by 40° C. and the stirring was stopped. Thereafter, the particles were classified by centrifugation in the liquid using a centrifuge and filtered by a sieve having an opening of 45 μm. Thus obtained filtrate is referred to as Associated Liquid. Non-spherical particles in a wet cake-like state were separated from Associated Liquid by filtration and washed by ion exchanged water. The non-spherical particles was dried at 60° C. by a flash jet drier and then further dried by a fluidized layer drying machine. To 100 parts by weight of the above prepared colored particles, one part by weight of silica minute particles was added and mixed by a Henschel mixer. Thus the toner prepared by an association method via emulsion polymerization was obtained.

Shapes and a variation coefficient of a shape factor of particles were controlled by adjusting rotation speed of stirrer and heating duration, while monitoring a salting out process, a fusion-adhering process and a shape controlling process. Further, particle diameters and a variation coefficient of particle size distribution were controlled via a liquid phase classification. Thus, toner 1Bk having shape properties-and particle size distribution properties shown in Table 2 was obtained. Instead of carbon black (Regal 330R), benzidine type yellow pigment was used for toner 1Y, quinacridon type Magenta pigment was used for toner 1M and quinacridon type Magenta pigment was used for toner 1C. The shape properties and particle size distribution properties were given in Table 2.

TABLE 2

| | | Number | | | | | |
|---|---|---|---|---|---|---|---|
| | Variation | Variation | | | | | |
| | Coefficient | Coefficient | Ratio | Ratio | | Number | |
| | of | Of Number | of | of | Ratio of | Average | |
| | Shape | Particle Size | Shape | Shape | Particles | Particle | Sum M |
| | Factor | Distribution | Factor | Factor | Without a | Diameter | of m₁ |
| Toner | (%) | (%) | 1.0-1.6(%) | 1.0-1.6(%) | Corner | (μm) | and m₂ |
| 1Bk | 13.1 | 25.7 | 86.2 | 73.2 | 85 | 5.3 | 72.3 |
| 1Y | 13.6 | 24.9 | 91.2 | 73.1 | 84 | 5.6 | 81.3 |
| 1M | 14.2 | 24.1 | 89.5 | 78.3 | 89 | 5.9 | 80.3 |
| 1C | 13.8 | 23.7 | 88.4 | 76.8 | 83 | 5.5 | 75.3 |

Preparation of Developing Agents

10 parts by weight of each toner in Table 2 was mixed with 100 parts by weight of ferrite carrier (particle size of 45 μm) coated with styrene—methacrylate copolymer to prepare toners 1Bk, 1Y, 1M and 1C for evaluation.

<Evaluation>

Using a digital color printer having an image forming device shown in FIG. 1 as a base structure, and in combinations of photoreceptors and exposure lights having various spot sizes as shown in Table 3, printing tests were carried out as follows. A continuous printing of 50,000 A4 size sheets was carried out under ambient temperature and normal humidity (20° C. and 50% RH). Both monochrome and color images containing letters (element factor: 8 percent) and half-tone images were printed. The ratio of monochrome printing and color printing was determined to be 9 to 1 considering the nature of tandem type color printer. Printing was stopped when it was necessary for the evaluations described below. Evaluation items and evaluation standards were described in the following. The results of the evaluation were summarized in Table 3.

<Dot Reproducibility of Monochrome Image>

Reproducibility of dots forming a black image was observed with a 100 times magnifier and evaluated. The dot reproducibility was evaluated with black images at the start of printing (S), after printing 10,000 sheets (10,000), and after printing 50,000 sheets (50,000).

A: Dot images are produced with ±30% in area compared with the exposure spot area, wherein the respective dot images are reproduced uncombined. (Excellent)

B: Dot images are produced with ±30% -±60% in area compared with the exposure spot area, wherein the respective dot images are reproduced uncombined. (Practical level)

C: Dot images are produced with exceeding ±60% in area compared with the exposure spot area, wherein the respective dot images are partially lost or connected. (Impractical level)

<Dot Reproducibility of Color Image>

Reproducibility of dots forming a color image was observed with a 100 times magnifier and evaluated. The dot reproducibility was evaluated with color images at the start of printing (S), after printing 10,000 sheets (10,000), and after printing 50,000 sheets (50,000).

A: A color image is reproduced with little unevenness between the respective dots of Bk, Y, M, and C (The difference between the area of the largest dot and the area of the smallest dot is smaller than 30% for each color.), and the color balance of the color image is excellent.

(Excellent)

B: A color image is reproduced with unevenness between the respective dots of Bk, Y, M, and C, wherein the difference between the area of the largest dot and the area of the smallest dot ranging from 30 to 60% for each color, and the color balance of the color image is maintained.

(Practical Level)

C: A color image is reproduced with a significant unevenness between the respective dots of Bk, Y, M, and C (The difference between the area of the largest dot and the area of the smallest dot is larger than 60% for each color.), and the color balance of the color image is lost.

(Impractical Level)

<Periodic Image Defects>

Occurrence of image defects (such as black spots (including color spots), white blanks, or line-shape image defects), which correspond with the cycle of the photoreceptors were evaluated, using a monochrome image and a color image after printing 50000 sheets.

Evaluation criteria are as follows.

A: Almost no apparent periodic image defects are observed. (less than 4 spots/A4 size sheet for black spots, density difference not greater than 0.02 for line shapes: Excellent)

B: Occurrence of apparent periodic image defects is within a practical range. (4 to 10 spots/A4 size sheet for black spots, density difference ranging from 0.03 to 0.04 for line shapes: Practical level)

C: Apparent periodic image defects occurred in a range requiring reexamination about practicality. (11 to 20 spots/A4 size sheet for black spots, density difference ranging from 0.05 to 0.06 for line shapes: Requiring reexamination of practicability)

D: Many apparent periodic defects occurred. (more than 20 spots/A4 size sheet for black spots, density difference of 0.07 or higher for line shapes: Impractical level)

<Sharpness>

Sharpness of image was evaluated for the resolution of a monochrome image and a color image after printing 50,000 sheets with the criteria below.

A: Resolution of a line image equal to or higher than 16 lines/mm is achieved. (Excellent)

B: Resolution of a line image in the range of 10-15 lines/mm is achieved. (Practical level)

C: Resolution of a line image equal to or lower than 9 lines/mm is achieved. (Improper as a high resolution image)

<Amount of Decrease in Layer Thickness of Photoreceptor Due to Abrasion by Repeated Use>

Amounts of decrease in layer thicknesses of monochrome type photoreceptors Bk and color type photoreceptors M of each photoreceptor group were determined.

(Amount of decrease in layer thickness: μm)=(Initial layer thickness of a photoreceptor: μm)−(Layer thickness of photoreceptor after printing 50,000 sheets: μm)

<Method for Measuring the Amount of Decrease in Layer Thickness>

An average value of thicknesses of 10 points in a uniform thickness area of a photoreceptor was adopted as the thickness of the photoreceptor. An eddy-current type instrument EDDY560C (Product of Helmut Fischer Fischer Gmbte Co.) was used to measure a layer thickness of a photoreceptor.

Results were shown in Table 3.

Other evaluation items:

Charging Condition of Photoreceptor: an electric potential of non-image part was detected by an electric potential sensor to provide a feed back control. The possible control range of the electric potential is −300 V-−1000 V.

Image-wise exposure light: A semiconductor laser with a wavelength of 780 nm.

Exposure Condition: Amount of light was set to give an electric potential of an exposed area in a range of −50 V to −150 V.

Spot Area of Exposure Light: A spot area of an exposure light was varied as shown in Table 3.

Developing Condition: The above mentioned developing agents 1Bk, 1Y, 1M and 1C were used. A reverse field process was adopted for developing.

TABLE 3

| | | | | | | | | | | | | Decrease | |
|---|---|---|---|---|---|---|---|---|---|---|---|---|---|
| | | | | | | | | | | | | in Photo-receptor | |
| | | | Dot | | | | | | | | | Thickness | |
| | | Exposure | Reproducibility | | | Dot | | | | | | (Photo-receptor | |
| | Photo- | Spot | in Monochrome | | | Reproducibility | | | Periodic | Sharpness | | Bk/ | |
| Combination | receptor | Area | Image | | | in Color Image | | | Image | Monochrome | Color | Photo-receptor M) | |
| No. | No. | μm² | S | 10,000 | 50,000 | S | 10,000 | 50,000 | Defect | Image | Image | μm | Remarks |
| 1 | Group 1 | 350 | A | A | A | A | A | A | A | A | A | 6.2/0.08 | inv. |
| 2 | Group 2 | 350 | A | A | B | A | A | B | A | A | A | 6.1/0.08 | inv. |
| 3 | Group 3 | 350 | A | B | B | A | B | B | B | A | B | 6.2/0.08 | inv. |
| 4 | Group 4 | 350 | A | A | B | A | A | B | A | A | A | 6.3/0.08 | inv. |
| 5 | Group 5 | 350 | A | A | A | A | A | A | A | A | A | 6.0/0.08 | inv. |
| 6 | Group 6 | 350 | A | A | B | B | B | B | B | A | B | 6.2/0.08 | inv. |
| 7 | Group 7 | 350 | A | B | B | B | B | C | B | B | C | 6.3/0.08 | ref. |
| 8 | Group 8 | 350 | A | B | C | B | B | C | B | C | C | 6.3/0.08 | ref. |
| 9 | Group 9 | 350 | A | B | C | B | C | C | D | C | C | 6.3/0.08 | Ref. |
| 10 | Group 1 | 800 | A | A | A | A | A | A | A | A | A | 6.2/0.08 | inv. |
| 11 | Group 1 | 1800 | A | A | B | A | A | B | A | B | B | 6.2/0.08 | inv. |

“inv.: present invention, ref.: reference”

Table 3 revealed that the combination Nos. 1-6, 10 and 11 in Table 3 each of which meets the requirement of the present invention, (namely, a changing rate of an exposure energy change (E_{600/100})ₙ is not larger than 0.01 (μJ/(cm²·μm)) when a surface potential of the organic photoreceptor varies from −600 V to −100 V give satisfactory results with respect to dot reproducibility, periodic image defects and sharpness both in monochrome and color images. However, in the case of combination Nos. 7-9 for references, degradation of dot reproducibility, specifically in color images was observed. Further, in the combination No. 9 of Table 3, larger degradation with respect to periodic defects compared with the combinations of the present invention was observed and, as a result, sharpness was also degraded. Among the combinations relating to the present invention, the combinations of which the changing rates of the exposure energy change (E_{600/100})ₙ of the photoreceptors were lower than 0.008 (μJ/(cm²·μm)) exhibited notable improvements. Namely, when the combination Nos. 1, 4 and 5 were compared with combination No. 6, improvements observed for the former (combination Nos. 1, 4 and 5) were obviously more noticeable than the latter (combination No. 6).

By using the organic photoreceptor of the present invention in a tandem type image forming apparatus, an electrophotographic image having sharpness and high resolution dot image and without occurrence of image defects is formed.

What is claimed is:

1. An organic photoreceptor comprising a conductive support on which a charge generating layer and a charge transporting layer are stacked in that order, wherein a changing rate of an exposure energy change (E_{600/100})ₙ is not larger than 0.01 (μJ/(cm²·μm)) when a thickness of the charge transporting layer “n” decreases from 20 μm to 15 μm and when a surface potential of the organic photoreceptor varies from −600 V to −100 V, the changing rate of the exposure energy change (E_{600/100})ₙ being defined by the following formula:
((E_{600/100})₂₀−(E_{600/100})₁₅)/(20−15)

2. The organic photoreceptor of claim 1, wherein an initial thickness of the charge transporting layer is in a range of 10 to 20 μm.

3. An image forming apparatus comprising:
(a) a plurality of image forming units, each of which corresponds to a different color toner and each of the image forming units comprising:
(i) an organic photoreceptor,
(ii) a charging member which provides electric charge to the organic photoreceptor and a surface of the organic photoreceptor,
(iii) an image-wise exposure member which exposes light to a charged area of the organic photoreceptor so as to form an electrostatic latent image on the surface of the photoreceptor,
(iv) a developing member which forms a toner image corresponding to the electrostatic latent image using a color toner on the surface of the organic photoreceptor, and
(v) a cleaning member which removes the toner remaining on the surface of the organic photoreceptor; and
(b) a transferring member which receives the toner image formed on the organic photoreceptor and transfers the toner image onto a transferring object,
wherein, the organic photoreceptor comprises a conductive support on which a charge generating layer and a charge transporting layer are formed in that order and a changing rate of an exposure energy change (E_{600/100})ₙ is not larger than 0.01 (μJ/cm²·μm) when a thickness of the charge transporting layer “n” decreases from 20 μm to 15 μm and when a surface potential of the organic photoreceptor varies from −600 V to −100 V, the changing rate of the exposure energy change (E_{600/100})ₙ being defined by the following formula:
(E_{600/100})₂₀−(E_{600/100})₁₅)/(20−15)

4. The image forming apparatus of claim 3, wherein a spot area of a spot image exposure light source used in the exposure member is not more than 2000 μm².

5. The image forming apparatus of claim 3, wherein an average particle diameter of toner particles in a developing powder used in the developing member is in a range of 2-8 μm.

6. An image forming method comprising-a step of forming an electrophtographic image using the image forming apparatus of claim 3.

7. An image forming unit for an image forming apparatus comprising:
(a) a plurality of image forming units, each of which corresponds to a different color toner and each of the image forming units comprising:
(i) an organic photoreceptor,
(ii) a charging member which provides electric charge to the organic photoreceptor and a surface of the organic photoreceptor,
(iii) an image-wise exposure member which exposes light to a charged area of the photoreceptor so as to form an electrostatic latent image on the surface of the photoreceptor,
(iv) a developing member which forms a toner image corresponding to the electrostatic latent image using a color toner on the surface of the organic photoreceptor, and
(v) a cleaning member which removes the toner remaining on the surface of the organic photoreceptor; and
(b) a transferring member which receives the toner image formed on the-organic photoreceptor and transfers the toner image onto a transferring object,
wherein, the organic photoreceptor comprises a conductive support on which a charge generating layer and a charge transporting layer are formed in that order and a changing rate of an exposure energy change (E_{600/100})ₙ is not larger than 0.01 (μJ/(cm²·μm)) when a thickness of the charge transporting layer “n” decreases from 20 μm to 15 μm and when a surface potential of the organic photoreceptor varies from −600 V to −100 V, the changing rate of the exposure energy change (E_{600/100})ₙ being defined by the following formula:
((E_{600/100})₂₀−(E_{600/100})₁₅)/(20−15)
